(19) United States
(12) Patent Application Publication
(10) Pub. No.: US 2026/0268629 A1
(43) Pub. Date: Sep. 10, 2026

(54) REFINED REGIONS OF INTEREST WITHIN AN IMAGE

(71) Applicant: QUALCOMM Incorporated, San Diego, CA (US)

(72) Inventors: Marko ANGJELICHINOSKI, San Diego, CA (US); Alexandros MANOLAKOS, Athens, Attikí (GR); Varun Amar REDDY, San Diego, CA (US); Sony AKKARAKARAN, Poway, CA (US); Kapil GULATI, Belle Mead, NJ (US)

(21) Appl. No.: 19/167,124

(22) PCT Filed: Feb. 21, 2024
(86) PCT No.: PCT/US2024/016635

§ 371 Date: Sep. 19, 2025

(30) Foreign Application Priority Data
May 12, 2023 (GR) 20230100385

(51) Int. Cl. G06V 10/25; G06V 20/50

(52) U.S. Cl. CPC G06V 10/25; G06V 20/50

(57) ABSTRACT

Techniques for determining a refined region of interest are described. In embodiments, the refined region of interest may be associated with a radio frequency (RF) device. The method may include: obtaining, from one or more sensors, sensor data corresponding to a scene associated with at least a portion of a target object, wherein the RF device is associated with the target object; obtaining, from the RF device or a storage device, status information relating to the RF device, object information relating to the target object, or a combination thereof; and performing an action with respect to the target object based on a region of interest associated with the sensor data, the region of interest corresponding to the RF device and at least a portion of the target object, wherein the region of interest is based at least in part on the status information, the object information, or the combination thereof.

### RELATED APPLICATIONS

This application claims the benefit of Greek Application No. 20230100385, filed May 12, 2023, entitled “REFINED REGIONS OF INTEREST WITHIN AN IMAGE”, which is assigned to the assignee hereof, and incorporated herein in its entirety by reference.

### BACKGROUND

### 1. Field of Disclosure

The present disclosure relates generally to the field of context-based device management, and more specifically to determining a refined region of interest associated with a radio frequency (RF) device.

### 2. Description of Related Art

A region of interest within an image may be indicative of a location or a possible location of an object or a portion of the object within the image. The region of interest can be indicated in the image using, e.g., a bounding box around the object in the image. Determining regions of interest can be useful in scenarios such as visual monitoring or surveillance in industrial environments (e.g., inventory management or item detection at a warehouse with objects (boxes, shelves, aisles, etc.)) or various other environments such as outdoor spaces or indoor environments (e.g., home, office).

### BRIEF SUMMARY

In some aspect of the present invention, a method of determining a refined region of interest associated with a mobile communication device is disclosed. In some embodiments, the method may include: obtaining, from one or more sensors, sensor data corresponding to a scene associated with at least a portion of a target object, wherein the RF device is associated with the target object; obtaining, from the RF device or a storage device, status information relating to the RF device, object information relating to the target object, or a combination thereof; and performing an action with respect to the target object based on a region of interest associated with the sensor data, the region of interest corresponding to the RF device and at least a portion of the target object, wherein the region of interest is based at least in part on the status information, the object information, or the combination thereof.

In some aspect of the present invention, a network apparatus is disclosed. In some embodiments, the network apparatus may include: one or more communication interfaces configured for data communication with one or more sensors and a storage device; one or more memory; and one or more processors communicatively coupled to the one or more communication interfaces and the one or more memory, and configured to: obtain, from the one or more sensors, sensor data corresponding to a scene associated with at least a portion of a target object, wherein the RF device is associated with the target object; obtain, from the RF device or the storage device, status information relating to the RF device, object information relating to the target object, or a combination thereof; and perform an action with respect to the target object based on a region of interest associated with the sensor data, the region of interest corresponding to the RF device and at least a portion of the target object, wherein the region of interest is based at least in part on the status information, the object information, or the combination thereof.

In some aspect of the present invention, a non-transitory computer-readable apparatus is disclosed. In some embodiments, the non-transitory computer-readable apparatus may include a storage medium, the storage medium including a plurality of instructions configured to, when executed by one or more processors, cause a computerized apparatus to: obtain, from one or more sensors, sensor data corresponding to a scene associated with at least a portion of a target object, wherein the RF device is associated with the target object; obtain, from the RF device or a storage device, status information relating to the RF device, object information relating to the target object, or a combination thereof; and perform an action with respect to the target object based on a region of interest associated with the sensor data, the region of interest corresponding to the RF device and at least a portion of the target object, wherein the region of interest is based at least in part on the status information, the object information, or the combination thereof.

In some aspect of the present invention, an apparatus is disclosed. In some embodiments, the apparatus may include: means for obtaining, from one or more sensors, sensor data corresponding to a scene associated with at least a portion of a target object, wherein the RF device is associated with the target object; means for obtaining, from the RF device or a storage device, status information relating to the RF device, object information relating to the target object, or a combination thereof; and means for performing an action with respect to the target object based on a region of interest associated with the sensor data, the region of interest corresponding to the RF device and at least a portion of the target object, wherein the region of interest is based at least in part on the status information, the object information, or the combination thereof.

This summary is neither intended to identify key or essential features of the claimed subject matter, nor is it intended to be used in isolation to determine the scope of the claimed subject matter. The subject matter should be understood by reference to appropriate portions of the entire specification of this disclosure, any or all drawings, and each claim. The foregoing, together with other features and examples, will be described in more detail below in the following specification, claims, and accompanying drawings.

### BRIEF DESCRIPTION OF THE DRAWINGS

FIG. 1 is a diagram of a positioning system, according to an embodiment.

FIG. 2A is an illustration of an example indoor environment having one or more target objects.

FIG. 2B is an illustration of an image of the example indoor environment of FIG. 2A.

FIG. 3A is an illustration of an example image of a target object with an RF device attached thereto, the example image having a region of interest around the target object.

FIG. 3B is an illustration of an example image of the target object with the RF device attached thereto of FIG. 3A, the example image having a refined region of interest determined according to embodiments herein.

FIG. 4A is an illustration of a visual prior constructed based on regions of interest within example images.

FIG. 4B is an illustration of a more informative visual prior constructed based on refined regions of interest within example images.

FIG. 5A is an example image of a target object (a user), the example image having a region of interest and a refined region of interest, the refined region of interest determined according to embodiments herein.

FIGS. 5B and 5C are example images of the target object (the user) using an RF device (e.g., UE), each example image representative of a different operation condition, each example image having a region of interest and a refined region of interest, the refined regions of interest determined according to embodiments herein.

FIG. 5D is an example image of the target object (the user) using an RF device (e.g., UE) in different operation conditions, with a region of interest and different refined regions of interest, each refined region of interest determined according to a different operation condition, and determined according to embodiments herein.

FIGS. 6A and 6B show an example image of target objects arranged according to some aspect of the target objects, each target object having a region of interest associated therewith.

FIG. 6C is an example image of a target object of FIG. 6A having multiple possible refined regions of interest identified according to embodiments herein.

FIG. 7 is a call flow diagram illustrating a process for determining a refined region of interest, according to some embodiments.

FIG. 8 is a flow diagram of a method determining a refined region of interest, according to some embodiments.

FIG. 9 is a block diagram of an embodiment of a computer system, which can be utilized in embodiments as described herein.

Like reference symbols in the various drawings indicate like elements, in accordance with certain example implementations. In addition, multiple instances of an element may be indicated by following a first number for the element with a letter or a hyphen and a second number. For example, multiple instances of an element 110 may be indicated as 110-1, 110-2, 110-3 etc. or as 110a, 110b, 110c, etc. When referring to such an element using only the first number, any instance of the element is to be understood (e.g., element 110 in the previous example would refer to elements 110-1, 110-2, and 110-3 or to elements 110a, 110b, and 110c).

### DETAILED DESCRIPTION

The following description is directed to certain implementations for the purposes of describing innovative aspects of various embodiments. However, a person having ordinary skill in the art will readily recognize that the teachings herein can be applied in a multitude of different ways. The described implementations may be implemented in any device, system, or network that is capable of transmitting and receiving radio frequency (RF) signals according to any communication standard, such as any of the Institute of Electrical and Electronics Engineers (IEEE) 802.15.4 standards for ultra-wideband (UWB), IEEE 802.11 standards (including those identified as Wi-Fi® technologies), the Bluetooth® standard, code division multiple access (CDMA), frequency division multiple access (FDMA), time division multiple access (TDMA), Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), 1xEV-DO, EV-DO Rev A, EV-DO Rev B, High Rate Packet Data (HRPD), High Speed Packet Access (HSPA), High Speed Downlink Packet Access (HSDPA), High Speed Uplink Packet Access (HSUPA), Evolved High Speed Packet Access (HSPA+), Long Term Evolution (LTE), Advanced Mobile Phone System (AMPS), or other known signals that are used to communicate within a wireless, cellular or internet of things (IoT) network, such as a system utilizing 3G, 4G, 5G, 6G, or further implementations thereof, technology.

As used herein, an “RF signal” comprises an electromagnetic wave that transports information through the space between a transmitter (or transmitting device) and a receiver (or receiving device). As used herein, a transmitter may transmit a single “RF signal” or multiple “RF signals” to a receiver. However, the receiver may receive multiple “RF signals” corresponding to each transmitted RF signal due to the propagation characteristics of RF signals through multiple channels or paths.

Additionally, unless otherwise specified, references to “reference signals,” “positioning reference signals,” “reference signals for positioning,” and the like may be used to refer to signals used for positioning of a user equipment (UE). As described in more detail herein, such signals may comprise any of a variety of signal types but may not necessarily be limited to a Positioning Reference Signal (PRS) as defined in relevant wireless standards.

Further, unless otherwise specified, the term “positioning” as used herein may absolute location determination, relative location determination, ranging, or a combination thereof. Such positioning may include and/or be based on timing, angular, phase, or power measurements, or a combination thereof (which may include RF sensing measurements) for the purpose of location or sensing services.

Various aspects relate generally to determining a refined region of interest, where the region of interest represents an area within an image (optical image, radio frequency (RF) representations, RF images, etc.) that is associated with a location (or possible location) of an RF device such as a mobile communication device (e.g., smartphone or other types of UEs) or a radio frequency identification (RFID) tag. A typical region of interest may be a pixel location on the image which identifies the general location of the RF device or a target object, but a refined region of interest may be determined based on additional contextual information, e.g., information about the RF device or information about the target object. In some approaches, the region of interest may be incrementally refined such that it provides more informative visual information.

Particular aspects of the subject matter described in this disclosure can be implemented to realize one or more of the following potential advantages. A refined region of interest may be more relevant, accurate, and narrowly tailored compared to typical regions of interest, resulting in more enhanced and useful results in downstream applications and actions such as positioning or visualization of the target object or a portion thereof (among other applications and actions as mentioned elsewhere below). The additional contextual information can be obtained relatively easily as well. Such information may include, for example, mode or activity of the RF device, the type of the target object that the RF device is attached to, the application or action to be performed with the refined region of interest, as a few examples.

Additional details will follow after an initial description of relevant systems and technologies.

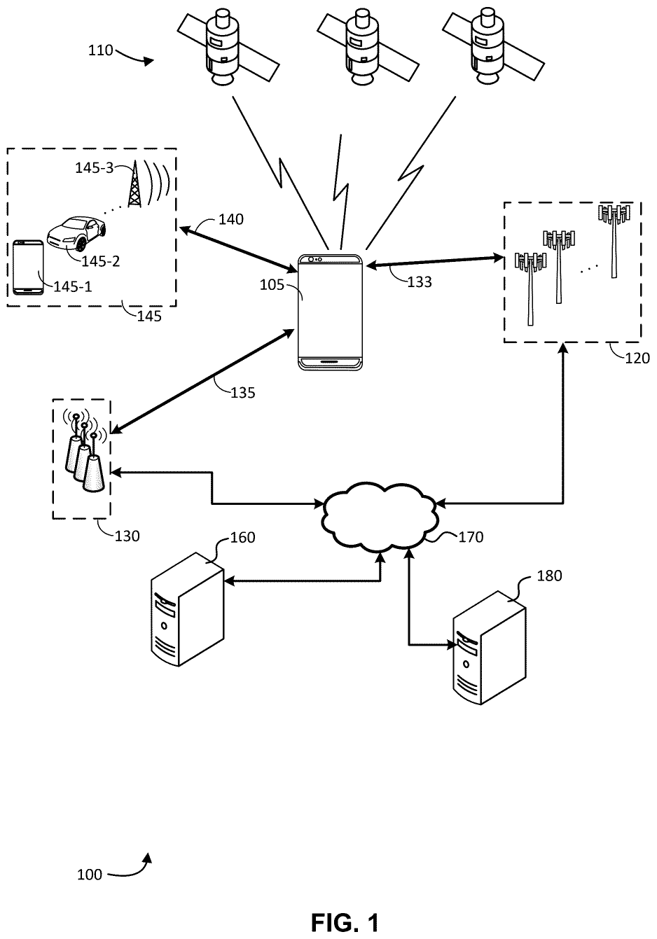

FIG. 1 is a simplified illustration of a positioning system 100 in which a radio frequency (RF) device 105, location server 160, and/or other components of the positioning system 100 can use the techniques provided herein for determining a refined region of interest within an image, and/or performing an action with respect to a target object, according to an embodiment. In various embodiments, the RF device 105 may include a wireless or mobile communication device, such as a UE (e.g., smartphone), a radio frequency identification (RFID) tag (passive or active), or another device capable of wireless communication with the access points described below or with one another. The techniques described herein may be implemented by one or more components of the positioning system 100. The positioning system 100 can include: an RF device 105; one or more satellites 110 (also referred to as space vehicles (SVs)), which may include Global Navigation Satellite System (GNSS) satellites (e.g., satellites of the Global Positioning System (GPS), GLONASS, Galileo, Beidou, etc.) and/or Non-Terrestrial Network (NTN) satellites; base stations 120; access points (APs) 130; location server 160; network 170; and external client 180. Generally put, the positioning system 100 can estimate a location of the RF device 105 based on RF signals received by and/or sent from the RF device 105 and known locations of other components (e.g., GNSS satellites 110, base stations 120, APs 130) transmitting and/or receiving the RF signals.

It should be noted that FIG. 1 provides only a generalized illustration of various components, any or all of which may be utilized as appropriate, and each of which may be duplicated as necessary. Specifically, although only one RF device 105 is illustrated, it will be understood that many RF devices (e.g., hundreds, thousands, millions, etc.) may utilize the positioning system 100. Similarly, the positioning system 100 may include a larger or smaller number of base stations 120 and/or APs 130 than illustrated in FIG. 1. The illustrated connections that connect the various components in the positioning system 100 comprise data and signaling connections which may include additional (intermediary) components, direct or indirect physical and/or wireless connections, and/or additional networks. Furthermore, components may be rearranged, combined, separated, substituted, and/or omitted, depending on desired functionality. In some embodiments, for example, the external client 180 may be directly connected to location server 160. A person of ordinary skill in the art will recognize many modifications to the components illustrated.

Depending on desired functionality, the network 170 may comprise any of a variety of wireless and/or wireline networks. The network 170 can, for example, comprise any combination of public and/or private networks, local and/or wide-area networks, and the like. Furthermore, the network 170 may utilize one or more wired and/or wireless communication technologies. In some embodiments, the network 170 may comprise a cellular or other mobile network, a wireless local area network (WLAN), a wireless wide-area network (WWAN), and/or the Internet, for example. Examples of network 170 include a Long-Term Evolution (LTE) wireless network, a Fifth Generation (5G) wireless network (also referred to as New Radio (NR) wireless network or 5G NR wireless network), a Wi-Fi WLAN, and the Internet. LTE, 5G and NR are wireless technologies defined, or being defined, by the 3rd Generation Partnership Project (3GPP). Network 170 may also include more than one network and/or more than one type of network.

The base stations 120 and access points (APs) 130 may be communicatively coupled to the network 170. In some embodiments, the base station 120s may be owned, maintained, and/or operated by a cellular network provider, and may employ any of a variety of wireless technologies, as described herein below. Depending on the technology of the network 170, a base station 120 may comprise a node B, an Evolved Node B (eNodeB or eNB), a base transceiver station (BTS), a radio base station (RBS), an NR NodeB (gNB), a Next Generation eNB (ng-eNB), or the like. A base station 120 that is a gNB or ng-eNB may be part of a Next Generation Radio Access Network (NG-RAN) which may connect to a 5G Core Network (5GC) in the case that Network 170 is a 5G network. The functionality performed by a base station 120 in earlier-generation networks (e.g., 3G and 4G) may be separated into different functional components (e.g., radio units (RUS), distributed units (DUs), and central units (CUs)) and layers (e.g., L1/L2/L3) in view Open Radio Access Networks (O-RAN) and/or Virtualized Radio Access Network (V-RAN or vRAN) in 5G or later networks, which may be executed on different devices at different locations connected, for example, via fronthaul, midhaul, and backhaul connections. As referred to herein, a “base station” (or ng-eNB, gNB, etc.) may include any or all of these functional components. An AP 130 may comprise a Wi-Fi AP or a Bluetooth® AP or an AP having cellular capabilities (e.g., 4G LTE and/or 5G NR), for example. Thus, RF device 105 can send and receive information with network-connected devices, such as location server 160, by accessing the network 170 via a base station 120 using a first communication link 133. Additionally or alternatively, because APs 130 also may be communicatively coupled with the network 170, RF device 105 may communicate with network-connected and Internet-connected devices, including location server 160, using a second communication link 135, or via one or more other mobile devices 145.

As used herein, the term “base station” may generically refer to a single physical transmission point, or multiple co-located physical transmission points, which may be located at a base station 120. A Transmission Reception Point (TRP) (also known as transmit/receive point) corresponds to this type of transmission point, and the term “TRP” may be used interchangeably herein with the terms “gNB,” “ng-eNB,” and “base station.” In some cases, a base station 120 may comprise multiple TRPs—e.g. with each TRP associated with a different antenna or a different antenna array for the base station 120. As used herein, the transmission functionality of a TRP may be performed with a transmission point (TP) and/or the reception functionality of a TRP may be performed by a reception point (RP), which may be physically separate or distinct from a TP. That said, a TRP may comprise both a TP and an RP. Physical transmission points may comprise an array of antennas of a base station 120 (e.g., as in a Multiple Input-Multiple Output (MIMO) system and/or where the base station employs beamforming). The term “base station” may additionally refer to multiple non-co-located physical transmission points, the physical transmission points may be a Distributed Antenna System (DAS) (a network of spatially separated antennas connected to a common source via a transport medium) or a Remote Radio Head (RRH) (a remote base station connected to a serving base station).

As used herein, the term “cell” may generically refer to a logical communication entity used for communication with a base station 120, and may be associated with an identifier for distinguishing neighboring cells (e.g., a Physical Cell Identifier (PCID), a Virtual Cell Identifier (VCID)) operating via the same or a different carrier. In some examples, a carrier may support multiple cells, and different cells may be configured according to different protocol types (e.g., Machine-Type Communication (MTC), Narrowband Internet-of-Things (NB-IoT), Enhanced Mobile Broadband (eMBB), or others) that may provide access for different types of devices. In some cases, the term “cell” may refer to a portion of a geographic coverage area (e.g., a sector) over which the logical entity operates.

Satellites 110 may be utilized for positioning of the RF device 105 in one or more ways. For example, satellites 110 (also referred to as space vehicles (SVs)) may be part of a Global Navigation Satellite System (GNSS) such as the Global Positioning System (GPS), GLONASS, Galileo or Beidou. Positioning using RF signals from GNSS satellites may comprise measuring multiple GNSS signals at a GNSS receiver of the RF device 105 to perform code-based and/or carrier-based positioning, which can be highly accurate. Additionally or alternatively, satellites 110 may be utilized for NTN-based positioning, in which satellites 110 may functionally operate as TRPs (or TPs) of a network (e.g., LTE and/or NR network) and may be communicatively coupled with network 170. In particular, reference signals (e.g., PRS) transmitted by satellites 110 NTN-based positioning may be similar to those transmitted by base stations 120, and may be coordinated by a location server 160. In some embodiments, satellites 110 used for NTN-based positioning may be different than those used for GNSS-based positioning. In some embodiments NTN nodes may include non-terrestrial vehicles such as airplanes, balloons, drones, etc., which may be in addition or as an alternative to NTN satellites.

The location server 160 may comprise a server and/or other computing device configured to determine an estimated location of RF device 105 and/or provide data (e.g., “assistance data”) to RF device 105 to facilitate location measurement and/or location determination by RF device 105. According to some embodiments, location server 160 may comprise a Home Secure User Plane Location (SUPL) Location Platform (H-SLP), which may support the SUPL user plane (UP) location solution defined by the Open Mobile Alliance (OMA) and may support location services for RF device 105 based on subscription information for RF device 105 stored in location server 160. In some embodiments, the location server 160 may comprise, a Discovered SLP (D-SLP) or an Emergency SLP (E-SLP). The location server 160 may also comprise an Enhanced Serving Mobile Location Center (E-SMLC) that supports location of RF device 105 using a control plane (CP) location solution for LTE radio access by RF device 105. The location server 160 may further comprise a Location Management Function (LMF) that supports location of RF device 105 using a control plane (CP) location solution for NR or LTE radio access by RF device 105.

In a CP location solution, signaling to control and manage the location of RF device 105 may be exchanged between elements of network 170 and with RF device 105 using existing network interfaces and protocols and as signaling from the perspective of network 170. In a UP location solution, signaling to control and manage the location of RF device 105 may be exchanged between location server 160 and RF device 105 as data (e.g. data transported using the Internet Protocol (IP) and/or Transmission Control Protocol (TCP)) from the perspective of network 170.

As previously noted (and discussed in more detail below), the estimated location of RF device 105 may be based on measurements of RF signals sent from and/or received by the RF device 105. In particular, these measurements can provide information regarding the relative distance and/or angle of the RF device 105 from one or more components in the positioning system 100 (e.g., GNSS satellites 110, APs 130, base stations 120). The estimated location of the RF device 105 can be estimated geometrically (e.g., using multiangulation and/or multilateration), based on the distance and/or angle measurements, along with known position of the one or more components.

Although terrestrial components such as APs 130 and base stations 120 may be fixed, embodiments are not so limited. Mobile components may be used. For example, in some embodiments, a location of the RF device 105 may be estimated at least in part based on measurements of RF signals 140 communicated between the RF device 105 and one or more other mobile devices 145, which may be mobile or fixed. As illustrated, other mobile devices may include, for example, a mobile phone 145-1, vehicle 145-2, static communication/positioning device 145-3, or other static and/or mobile device capable of providing wireless signals used for positioning the RF device 105, or a combination thereof. Wireless signals from mobile devices 145 used for positioning of the RF device 105 may comprise RF signals using, for example, Bluetooth® (including Bluetooth Low Energy (BLE)), IEEE 802.11x (e.g., Wi-Fi®), Ultra Wideband (UWB), IEEE 802.15x, or a combination thereof. Mobile devices 145 may additionally or alternatively use non-RF wireless signals for positioning of the RF device 105, such as infrared signals or other optical technologies.

Mobile devices 145 may comprise other RF devices (e.g., UEs) communicatively coupled with a cellular or other mobile network (e.g., network 170). When one or more other mobile devices 145 comprising RF devices are used in the position determination of a particular RF device 105, the RF device 105 for which the position is to be determined may be referred to as the “target RF device,” and each of the other mobile devices 145 used may be referred to as an “anchor RF device.” For position determination of a target RF device, the respective positions of the one or more anchor RF devices may be known and/or jointly determined with the target RF device. Direct communication between the one or more other mobile devices 145 and RF device 105 may comprise sidelink and/or similar Device-to-Device (D2D) communication technologies. Sidelink, which is defined by 3GPP, is a form of D2D communication under the cellular-based LTE and NR standards. UWB may be one such technology by which the positioning of a target device (e.g., RF device 105) may be facilitated using measurements from one or more anchor devices (e.g., mobile devices 145).

According to some embodiments, such as when the RF device 105 comprises and/or is incorporated into a vehicle, a form of D2D communication used by the mobile device 105 may comprise vehicle-to-everything (V2X) communication. V2X is a communication standard for vehicles and related entities to exchange information regarding a traffic environment. V2X can include vehicle-to-vehicle (V2V) communication between V2X-capable vehicles, vehicle-to-infrastructure (V2I) communication between the vehicle and infrastructure-based devices (commonly termed roadside units (RSUs)), vehicle-to-person (V2P) communication between vehicles and nearby people (pedestrians, cyclists, and other road users), and the like. Further, V2X can use any of a variety of wireless RF communication technologies. Cellular V2X (CV2X), for example, is a form of V2X that uses cellular-based communication such as LTE (4G), NR (5G) and/or other cellular technologies in a direct-communication mode as defined by 3GPP. The RF device 105 illustrated in FIG. 1 may correspond to a component or device on a vehicle, RSU, or other V2X entity that is used to communicate V2X messages. In embodiments in which V2X is used, the static communication/positioning device 145-3 (which may correspond with an RSU) and/or the vehicle 145-2, therefore, may communicate with the RF device 105 and may be used to determine the position of the RF device 105 using techniques similar to those used by base stations 120 and/or APs 130 (e.g., using multiangulation and/or multilateration). It can be further noted that mobile devices 145 (which may include V2X devices), base stations 120, and/or APs 130 may be used together (e.g., in a WWAN positioning solution) to determine the position of the RF device 105, according to some embodiments.

An estimated location of RF device 105 can be used in a variety of applications—e.g. to assist direction finding or navigation for a user of RF device 105 or to assist another user (e.g. associated with external client 180) to locate RF device 105. A “location” is also referred to herein as a “location estimate”, “estimated location”, “location”, “position”, “position estimate”, “position fix”, “estimated position”, “location fix” or “fix”. The process of determining a location may be referred to as “positioning,” “position determination,” “location determination,” or the like. A location of RF device 105 may comprise an absolute location of RF device 105 (e.g. a latitude and longitude and possibly altitude) or a relative location of RF device 105 (e.g. a location expressed as distances north or south, east or west and possibly above or below some other known fixed location (including, e.g., the location of a base station 120 or AP 130) or some other location such as a location for RF device 105 at some known previous time, or a location of a mobile device 145 (e.g., another RF device) at some known previous time). A location may be specified as a geodetic location comprising coordinates which may be absolute (e.g. latitude, longitude and optionally altitude), relative (e.g. relative to some known absolute location) or local (e.g. X, Y and optionally Z coordinates according to a coordinate system defined relative to a local area such a factory, warehouse, college campus, shopping mall, sports stadium or convention center). A location may instead be a civic location and may then comprise one or more of a street address (e.g. including names or labels for a country, state, county, city, road and/or street, and/or a road or street number), and/or a label or name for a place, building, portion of a building, floor of a building, and/or room inside a building etc. A location may further include an uncertainty or error indication, such as a horizontal and possibly vertical distance by which the location is expected to be in error or an indication of an area or volume (e.g. a circle or ellipse) within which RF device 105 is expected to be located with some level of confidence (e.g. 95% confidence).

The external client 180 may be a web server or remote application that may have some association with RF device 105 (e.g. may be accessed by a user of RF device 105) or may be a server, application, or computer system providing a location service to some other user or users which may include obtaining and providing the location of RF device 105 (e.g. to enable a service such as friend or relative finder, or child or pet location). Additionally or alternatively, the external client 180 may obtain and provide the location of RF device 105 to an emergency services provider, government agency, etc.

In some implementations, the example positioning system 100 can be implemented using a wireless communication network, such as an LTE-based or 5G NR-based network.

### Refining a Region of Interest

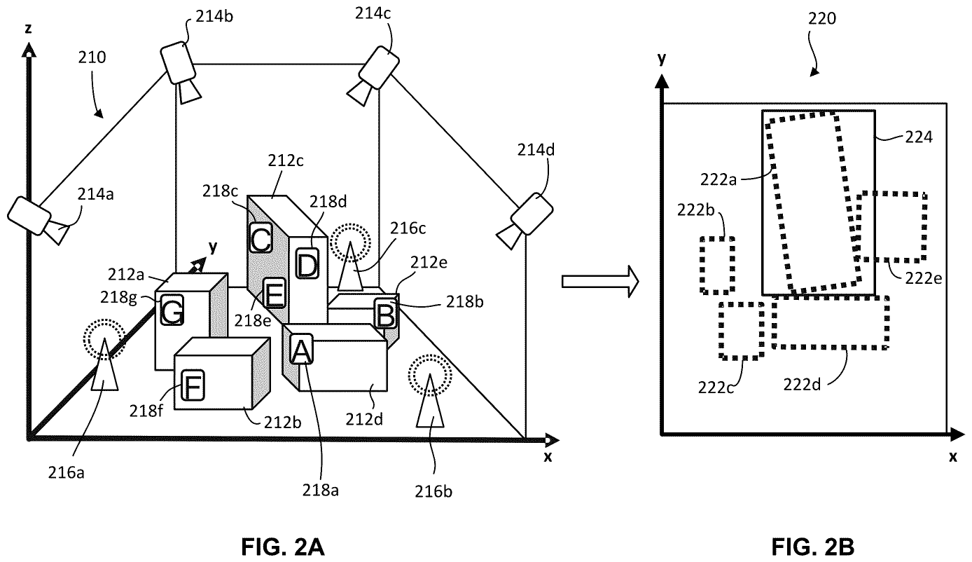

FIG. 2A is an illustration of an example indoor environment 210 having one or more target objects 212a-212e. Such target objects may be visible and in the line of sight of one or more image-capturing apparatus (e.g., cameras 214a-214d) positioned in the example indoor environment 210. In some cases, the image-capturing apparatus may include one or more radio frequency (RF) sensors configured to detect RF signals and cause generation of RF representations or RF images. In some cases, a number of cameras and/or RF sensors may be used depending on the application or level of visual information desired.

In some implementations, the example indoor environment 210 may further include one or more access points 216a-216c. The access points 216a-216c may be configured to communicate wirelessly with the one or more image-capturing apparatus and/or one or more RF devices 218a-218f. In some implementations, the access points 216a-216c may receive image data from the one or more image-capturing apparatus, and send the image data to the network (e.g., a server); or the access points 216a-216c may receive requests from the network (e.g., the server) to obtain information about the RF devices 218a-218f or the target objects 212a-212e, as will be further discussed elsewhere.

In some scenarios, RF devices 218a-218f may be associated with the target objects 212a-212e. In some cases, the association of an RF device with a target object may include co-location with the target object (e.g., a person). In some cases, the RF device and the target may not be co-located (e.g., located in different rooms or areas). In different implementations, an RF device may be a wireless or mobile communication device, such as a UE (e.g., smartphone), RFID tag (passive or active), or another device capable of wireless communication (e.g., with access points 216a-216c, base stations of a wireless communication network, another RF device (e.g., RF reader), or with one another). In this context, association may refer to an RF device being attached to a target object, in contact with the target object, within the target object (e.g., a box), in communication with the target object (e.g., between a user and a UE placed away from the user), within a certain distance from the target object, or a combination thereof. These are illustrative examples, and other types of association may occur between an RF device and a target object.

In the illustrated example of FIG. 2A, RF device “A” 218a is associated with target object 212d, RF device “B” 218b is associated with target object 212e, RF devices “C” 218c, “D” 218d, and “E” 218e are associated with target object 212c, RF device “F” 218f is associated with target object 212b, and RF device “G” 218g is associated with target object 212a. As can be seen, multiple RF devices can be associated with a given target object. A given RF device can be associated with multiple target objects as well; e.g., an RF device may be associated with a shelf of boxes. In some cases, multiple possible locations for at least one RF device may be associated with a target object (e.g., at least one RF device within a box and not visible in an image). As will be further detailed elsewhere, such possible locations may have respective probabilities or likelihoods associated therewith.

FIG. 2B is an illustration of an example image 220 of the example indoor environment 210 of FIG. 2A. In some embodiments, the cameras 214a-214d may obtain one or more images of the example indoor environment 210, resulting in the image 220 representing the example indoor environment 210. In some approaches, the image 220 may be derived from one image obtained by one or more of the cameras 214a-214d, or the image 220 may be derived from multiple images combined into a composite image. Other approaches known in the relevant arts may be used to obtain the image 220 of the example indoor environment 210.

In the illustrated example of FIG. 2B, the image 220 may include a top-down view of the target objects shown in FIG. 2A, including object representations 222a-222e corresponding to target objects 212a-212e. The image 220 may be a two-dimensional representation of the example indoor environment 210 on the x-y plane. A region of interest 224 may be shown around a target object. In this example, the region of interest 224 may be a bounding box that indicates the pixel location of the target object 222a.

In some embodiments, a region of interest may be generated to identify the part of an image where an RF device might be present. For instance, a bounding box may be obtained via object detection configured to identify specific types of objects. Furthermore, the region of interest may be associated across images, which may allow identification of the same region of interest in multiple images, or the region of interest may be associated with an RF device, which may allow determination of which RF device is contained in a given region of interest.

Each region of interest may contain one or more RF devices. However, the actual location of an RF device is typically not known, since the RF device is not being directly detected. In other words, the RF device can be anywhere within the corresponding region of interest. Although the RF device could be anywhere within a given region of interest, the region of interest can be used as supporting basis for various applications or actions, such as determining a position of the RF device and/or a target object associated with the RF device. Another such application or action is visualization of the position of the target object and/or RF device, e.g., in three-dimensional coordinates, as will be discussed in further detail below in terms of a “visual position prior” or a “visual prior.”

In some implementations, the region of interest 224 may be determined and placed on the image 220 based at least on imaging techniques applied to objects, such as feature extraction, pattern recognition, feature classification, or the like. In some implementations, at least one RF device associated with a target object may be used to determine and/or select the region(s) of interest. For example, based on information of a location of the RF device, a region of interest can be determined to be around an object having a similar location. In some implementations, camera parameters and/or orientations of the cameras may be considered in determining the region of interest 224.

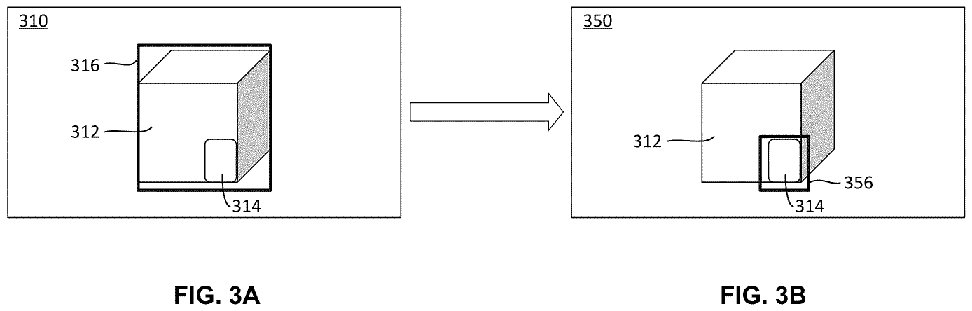

The region of interest 224 can be used to determine a position of the target object 222a. However, as will be discussed below, some scenarios can benefit from a more refined region of interest, such as a bounding box or any bounding shape that more precisely indicates a location or possible location of an RF device or a target object, which may result in more precise, more relevant, and more informative positioning or other downstream applications or actions with the refined region of interest. A refined region of interest may take any polygonal or freeform shape as needed. Distinctions between a typical region of interest and a refined region of interest will be described with respect to FIGS. 3A-6B.

FIG. 3A is an illustration of an example image 310 of a target object 312 with an RF device 314 attached thereto, the example image having a region of interest 316 around the target object 312. As shown in the example image 310, the target object 312 may be a box. As noted above, the RF device 314 may be a wireless or mobile communication device, e.g., a smartphone or RFID tag, and may be an example of one of the RF devices 218a-218f. A region of interest 316, in this case a bounding box, may be visually determined from the example image 310, using one or more of the approaches mentioned above. However, the RF device 314 may or may not be visible in the example image 310 (e.g., if it is inside the box).

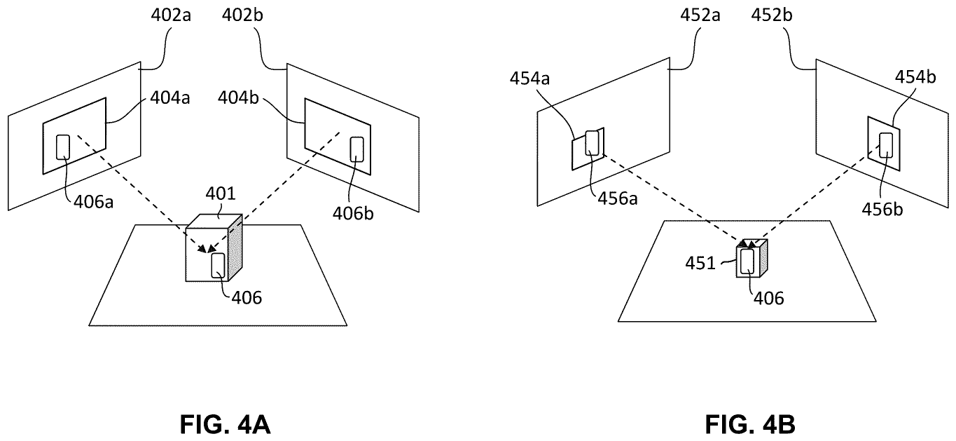

The region of interest 316 visually indicates the location of the target object 312 and the RF device 314 on the example image 310. Using the example image 310 (or in some cases, one or more images similar to the example image 310 in addition), a “visual position prior” or a “visual prior” can be constructed and generated. A “visual position prior” or a “visual prior” in this context may refer to a representation, or a set of parameters, of a target object or an RF device associated with the target object, the representation being in a different space than the image used to construct the representation. For example, region in a three-dimensional coordinate system may be determined using one or more two-dimensional images, the information contained in the one or more images (e.g., a region of interest), status information relating to the RF device, information relating to the target object (e.g., object type), prior knowledge of location of the RF device, other information obtainable from the RF devices or elsewhere such as the network, or a combination thereof. The visual prior in the three-dimensional coordinate system can, for instance, be constructed through a back projection of one or more regions of interest defined over the one or more two-dimensional images. The more informative a visual prior is, the more accurate the location or position of the RF device or target object may be considered to be. With a more informative visual prior and more accurate location information (e.g., a small three-dimensional region where the RF device or target object may be located), the more effective a downstream application or action using the visual prior can be. For example, more accurate or granular monitoring of objects can be performed (e.g., by accurately isolating each item in a crowded group of items in an industrial environment, or determining a more accurate location of a UE relative to a user). Visual priors can be made more informative by refining the region of interest according to embodiments described herein. FIGS. 4A and 4B illustrate examples of informative visual priors being constructed.

An informative region of interest is characterized by three principles: (1) The region of interest contains the RF device. (2) Smaller regions of interest are generally more useful and generally lead to more informative visual information. (3) The visual prior defined by the region of interest is likely to be located on the image in which the region of interest is identified. In some cases, the region of interest can be further refined by incorporating additional contextual information that pertains to the status, activity, object type, and/or location of the RF device and/or the target object. In some cases, the region of interest can be further refined by post-processing the region of interest initially determined using the aforementioned additional contextual information.

Such additional contextual information can be defined as any “domain knowledge” or information that pertains to the RF device or the target object. A target object may refer to any object, item, or user to which the RF device is associated. A target object can be used to obtain a region of interest for informative visual priors (and meets the three principles above). Such additional domain information can include a variety of information that can categorized into two broad groups: status information relating to the RF device, as well as object information relating to the target object (e.g., a target object to which the RF device is associated).

More specifically, in various embodiments, examples of status information can include or be based on at least one the following:

Communication information. In some implementations, the communication information may include a call status that is indicative of whether the RF device (e.g., a smartphone or another UE) is in an active call. In some implementations, the communication information may include a communication status that is indicative of whether the RF device is in communication with another device (e.g., via an access points 216a-216c, a base station of a wireless communication network, or device-to-device communication with another RF device). In some implementations, the communication information may include a connectivity status that is indicative of whether the RF device is actively connected to a short-range wireless network (e.g., with Bluetooth devices) or is using a short-range communication protocol (e.g., a near-field communication (NFC) protocol), as some examples.

Operational information., implementations, the operational information may include an activity status indicative of whether the RF device is locked or unlocked (e.g., whether the use of a UE is authenticated, or whether certain functions or a majority of functions of a UE are usable by a user), whether and/or how the RF device is actively being used (e.g., reading, typing, or scrolling is detected on the UE), or whether the RF device (e.g., a UE) is in speaker mode, as some examples.

Motion information. In some implementations, the motion information may include a motion status indicative of whether the RF device is in motion. For example, a UE or mobile communication device (e.g., smartphone) may be on the person of a user who is moving. Motion status can be determined according to various approaches, e.g., using a gyroscope, or determining a difference in locations derived using UE-based or UE-assisted positioning methods mentioned above.

Distance information. In some implementations, the distance information may be with respect to the target object, and may include a proximity status indicative of a distance or range of the RF device with respect to the target object and/or whether the distance is within or outside a distance threshold. In some cases, the distance may be known and stored on the network (e.g., server or a storage such as a database). Industrial settings, warehouses, or other environments having standard procedures may be an example of scenarios that employ standardized or known placements of objects or distances between objects. In some cases, the distance may be determined visually using an image such as image 220, e.g., with reference to a known pixel-to-pixel distance. In some cases, the distance may be determined using RF signals sent by the RF device and reflected from the target object (e.g., using RTT). In some scenarios, distance information can also be calculated in virtual reality (VR), augmented reality (AR), or mixed reality (MR) settings using the parameters discussed above (e.g., known data, known reference distance).

Location information. In some implementations, the location information may indicate a geodetic, relative, or local location, as described above, of the RF device. The location information may not only be used to refine the region of interest but also to determine the aforementioned distance information.

Placement information of the RF device. In some implementations, the placement information may be relative to a target object, which may in some cases be determined based on the aforementioned distance information. In some implementations, the placement information may indicate one or more possible locations at which the RF device may be placed. For example, the RF device may be inside a box and located at one of the eight corners of the box.

Type of placement. In some implementations, the type of placement may relate to the placement of the RF device relative to the target object. Using the above example of the RF device being possibly located at one of the eight corners of the box, the type of placement may be “corner.” This information could indicate that the RF device may be in a corner of objects that do not have eight distinct corners (a flat box that has four corner placements, a table having four corners, a triangular container, etc.). Another example is the type of placement being an orientation or location relative to the target object. For example, the RF device may be behind or below a target object; in front of or above the target object; inside or outside the target object; or visible, invisible, or partially visible.

In various embodiments, examples of object information can include or be based on at least one the following:

Object type. In some implementations, the object type may be a type of the target object. The object type may include various descriptors of aspects of the target object to which the device is associated: size, dimension(s), weight, color, category, whether the target object is a container, etc. Objects may be organized in some structured way, such as by one of the descriptor listed above.

Placement information of the target object. In some implementations, the placement information may indicate a placement or location of the target object relative to other objects or target objects. For example, the placement information may indicate that the target object is at a particular shelf as opposed to another shelf, or is in a particular warehouse as opposed to another one. In some implementations, the placement information may be based on the object type discussed above. For example, objects of certain a size range (or range of other aspects such as weight) may be organized to be at a certain location, such as a bottom shelf for heavier items. In some implementations, the placement information may indicate a possible position or likely position of the RF device on the target object, or a type of placement. Example of the foregoing may include which corner the RF device is at or could be at, or whether the RF device is placed at a corner, on the side, or inside the target object (e.g., box). This placement information may be related to or have overlap with the placement information and the type of placement discussed above.

In some embodiments, contextual information such as status information and object information may be obtained (e.g., by a server) from a storage (e.g., a database) or the RF device (e.g., by request or received periodically). When at least some of the foregoing contextual information is available to provide additional information that pertains to the activity, status, object type, location, etc. of the RF device and/or the target object, the region of interest can be refined by incorporating the information to determine the refined region of interest. In some implementations, a refined region of interest may be further refined using the same contextual information, different portions of the status information and/or object information, or newly obtained contextual information. That is, an initial region of interest may be refined more than once.

The aforementioned status information and object information are illustrative examples. Other types of status information of the RF device (e.g., information relating to, pertaining to, associated with the RF device) and/or object information of the target object (e.g., information relating to, pertaining to, associated with the target object) may be used with similar effectiveness.

Referring now to FIG. 3B, an illustration of an example image 350 of the target object 312 with the RF device 314 attached thereto of FIG. 3A, the example image 350 having a refined region of interest 356 determined according to embodiments herein. The refined region of interest 356 in this example is a bounding box that is noticeably smaller than the region of interest 316 of FIG. 3A. The refined region of interest 356 may have been determined using at least some of the contextual information discussed above. The RF device 314 still may not be visible in the example image 350. However, the refined region of interest 356 may be more accurate as to the location (or possible location) of the RF device 314.

FIG. 4A is an illustration of a visual prior 401 constructed based on regions of interest 404a, 404b within example images 402a, 402b. In this example, multiple regions of interest 404a, 404b may be determined. Each region of interest 404a, 404b may be indicative of a pixel location of an RF device 406 and/or a target object (not shown), and may be determined within example images 402a, 402b based on imaging techniques, location information of RF device 406, and/or camera parameters, as discussed with respect to FIG. 2B. Although indications 406a, 406b of where the RF device 406 might be are shown in the example images 402a, 402b for illustrative purposes, the example images 402a, 402b may or may not actually show the RF device 406. According to some approaches, the regions of interest 404a, 404b may be back projected to determine the visual prior 401, which may be a three-dimensional region representative of the position of the RF device 406 and/or the target object. In some specific scenarios, the visual prior 401 may be a box-shaped region that contains the target object, which in this case may be a box.

FIG. 4B is an illustration of a more informative visual prior 451 constructed based on refined regions of interest 454a, 454b within example images 452a, 452b. As can be seen, the refined regions of interest 454a, 454b have one or more smaller dimensions as compared to the regions of interest 404a, 404b, and the more informative visual prior 451 may be a three-dimensional region that has one or more smaller dimensions as compared to the visual prior 401. According to some approaches, the refined regions of interest 454a, 454b may be back projected to determine the more informative visual prior 451. Although indications 456a, 456b of where the RF device 406 might be are shown in the example images 452a, 452b for illustrative purposes, the example images 402a, 402b may or may not actually show the RF device 406.

The more informative visual prior 451 may be indicative of a more accurate location or position of the RF device 406, whereas the visual prior 401 was indicative of a relatively more general location of the RF device 406 and/or the target object. In some specific scenarios, the visual prior 401 may be a box-shaped region that contains the RF device and a portion of the target object rather than the entire target object (e.g., the entire box). The visual prior 451 can be used to infer the position of the RF device directly. This can be useful for cases where isolating a more specific location of the target object is desired, e.g., where multiple boxes are crowded together or where the position of a specific part of the target object is desirable.

In some implementations, determination or corroboration of a location or position of a RF device and/or a target object (or portion thereof) may be based on a visual prior as well as RF signals using RF transmitters and RF sensors. For example, RF-based position estimates may be obtained, e.g., via round trip signal propagation delay (RTT). As another example, RF signals may also be used to generate RF images or RF representations, where further regions of interest may be determined. In some cases, one or more measurements may be obtained, such as range or angle (e.g., angle of arrival (AoA) or angle of departure (AoD)) estimates with respect to RF devices (coinciding with regions of interest), where the one or more measurements may be used with the visual prior to determine or corroborate the location of the RF device and/or target object.

In some embodiments, fewer or additional images (compared to, e.g., the two example images 452a, 452b) may be obtained, e.g., from different or same cameras or RF sensors. With one or more additional images, one or more corresponding refined regions of interest may be determined for a given RF device, e.g., based on contextual information of the types discussed above. Additional refined regions of interest may result in an even more informative visual prior.

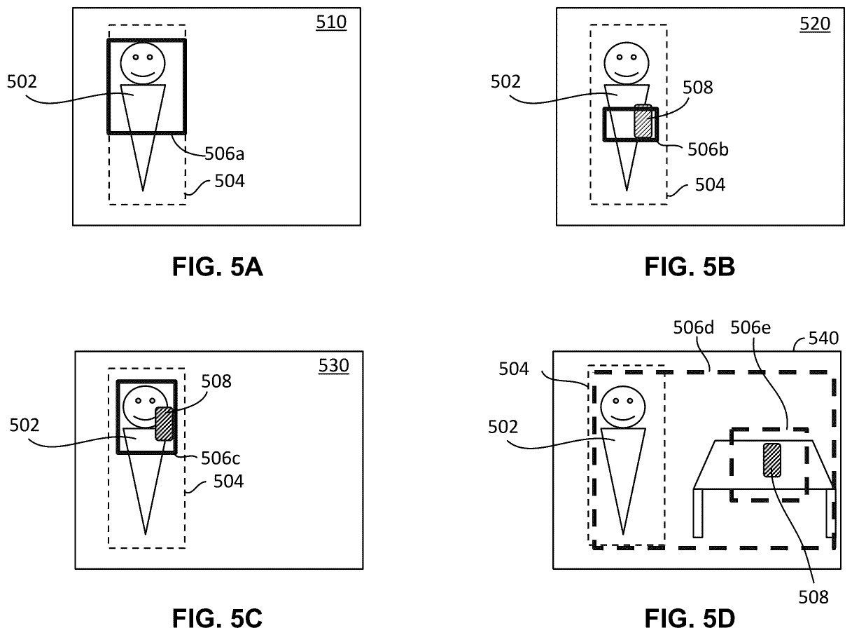

In addition, association of regions of interest across images and/or across RF devices can advantageously benefit from more informative, more precise regions of interest and more informative visual priors. For instance, association of regions of interest with RF devices in crowded scenarios with many objects or many users can significantly benefit from smaller regions of interest that overlap as little as possible and that capture as much as possible relevant information while minimizing the redundant information. Illustrative example scenarios involving a user will be described with respect to FIGS. 5A-5D.

FIG. 5A is an example image 510 of a target object (a user 502), the example image 510 having a region of interest 504 and a refined region of interest 506a, the refined region of interest 506a determined according to embodiments herein. In some embodiments, the refined region of interest 506a may be determined based on additional contextual information as discussed elsewhere herein. In some situations, the additional contextual information may have certain assumption(s). For example, a user typically carries an RF device (e.g., a UE such as a smartphone) in proximity of the upper part of the body (e.g., next to ear, in a pocket, in a purse). The region of interest 504 (which may be an initial region of interest without considering contextual information) may then be refined using contextual information as well as the assumption(s) to focus on the upper part of the body of the user 502 to determine a refined region of interest 506a. Notably, the region of interest 504 and the refined region of interest 506a may have at least one different dimension. In this example, the refined region of interest 506a may have a smaller height and focus on the upper portion of the user's body. With additional contextual information, the width may be narrowed as well. In some scenarios, however, one dimension of the region of interest may enlarge rather than become smaller, with the total area of the refined region of interest still being smaller than the initial region of interest.

FIGS. 5B and 5C are example images 520, 530 of the target object (the user 502) using an RF device (e.g., UE 508), each example image 520, 530 representative of a different operation condition, each example image 520, 530 having a region of interest 504 and a refined region of interest 506b, 506c, the refined regions of interest 506b, 506c determined according to embodiments herein.

In the example of FIG. 5B, contextual information such as communication information (e.g., call status) and/or operational information (e.g., lock status) may be considered when determining the refined region of interest 506b. For example, if the UE 508 is not in an active call and/or is locked, this information may imply that the UE 508 is not being used by the user 502. Users typically carry UEs on their person, e.g., pocket or purse as noted above. This is an assumption that can provide additional information. The region of interest 504 can be refined to focus on the middle of the body using the communication information, operational information, and/or the assumption. A refined region of interest 506b may be determined thereby on the example image 520.

In contrast, referring to the example of FIG. 5C, if the UE 508 is unlocked and/or is on an active call (determined, e.g., based on the call status and/or lock status mentioned above), this contextual information may imply that the UE 508 is being used by the user 502. Most users keep the UE near their heads, even when the UE is in speaker mode. In some scenarios, the UE may be a pair of earbuds that are equipped in the user's ears. These are assumptions that can provide additional information. Using the contextual information above and/or the assumption(s), the region of interest 504 can be refined to focus on the top part of the body (e.g., head of the user 502). A refined region of interest 506c may be determined thereby on the example image 530. In some scenarios, however, one or more of the dimensions of the region of interest may enlarge rather than become smaller, with the total area of the refined region of interest still being smaller than the initial region of interest, or in some cases larger than the initial region of interest.

FIG. 5D is an example image 540 of the target object (the user 502) using an RF device (e.g., UE 508) in different operation conditions, with a region of interest 504 and different refined regions of interest 506d, 506e, each refined region of interest 506d, 506e determined according to a different operation condition, and determined according to embodiments herein.

If the UE 508 is in a call in speaker mode (determined using, e.g., call status), connected to a Bluetooth device (e.g., external speaker, earbuds) (determined using, e.g., connectivity status), and/or in different motion state than the person (e.g., walking while UE 508 is stationary) (stationary status determined using, e.g., motion status), this information may indicate that the UE 508 might be placed in proximity to the person (e.g., on a table) but not directly on the person. Based on such contextual information, the region of interest 504 may be refined to incorporate the surroundings, resulting in a refined region of interest 506d. The refined region of interest 506d includes the UE 508, the user 502, and the table. Either or both of the user 502 or the table may be considered a target object depending on the application or the action (e.g., which object is to be positioned).

In some cases, further contextual information may be used. If distance information such as the range between user 502 and UE 508 is available, the region of interest (either the initial region of interest 504 or the refined region of interest 506d) may be refined even further to a refined region of interest 506e based on the distance information and/or the previously listed contextual information used to determine the refined region of interest 506d.

In some implementations, a visual search (e.g., using aforementioned imaging techniques) may occur based on a proximity to the RF device (e.g., UE 508). In an example approach, visual searching may begin at an initial location in an image (such as example image 540). Examples of the initial location may include a predetermined location (e.g., center of image), a location of a salient object (e.g., user 502 or a table or another object or a portion thereof), or an arbitrary location (e.g., selected randomly). The where visual searching may start with a relatively narrow window or frame at the initial location and gradually expand until one or more relevant target object(s) are detected. The relevance of the target object(s) and the extent of the visual search may be based on contextual information as discussed above. The greater the proximity, the smaller the visual searching may expand. In some cases, proximity or distance information such as the range between user 502 and UE 508 may be used if available. For example, knowing the distance between a target object (e.g., user 502) and a table or the RF device (e.g., UE 508) may provide an expectation that the region of interest should be expanded at least the distance so as to encompass the user 502 and the table, such as in the refined region of interest 506d of FIG. 5D.

As such, incorporating domain knowledge and contextual information can enable determination of refined regions of interest, which can be used to determine visual priors and/or to perform applications or actions with target objects, such as more accurate positioning. Another example scenario involving warehouse monitoring of objects such as boxes is described below.

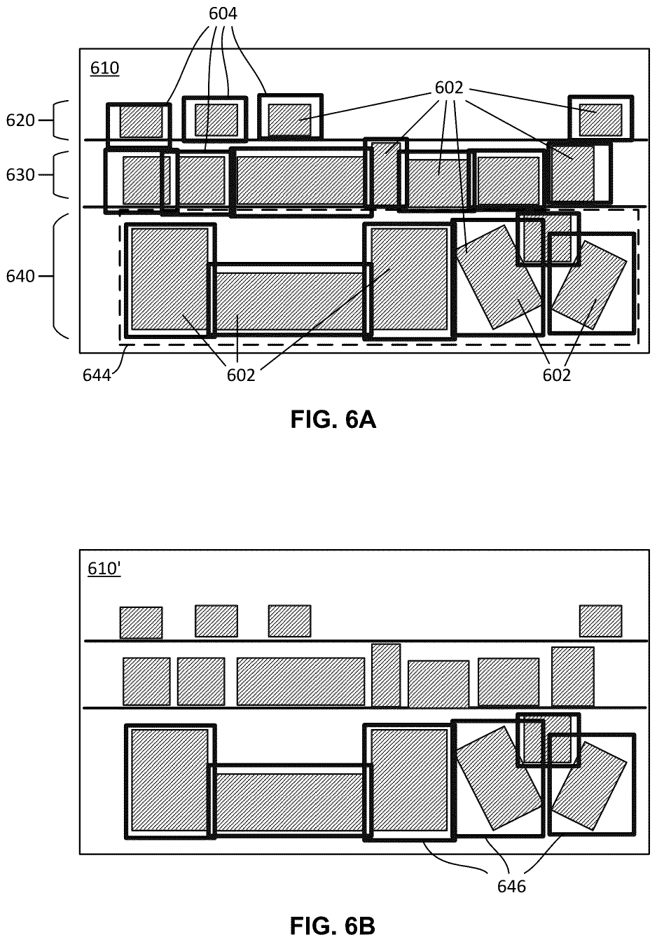

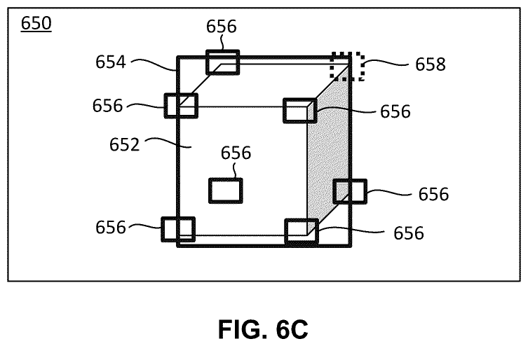

FIG. 6A is an example image 610 of target objects arranged according to some aspect of the target objects 602, each target object 602 having a region of interest 604 associated therewith. For simplicity, not all target objects and not all regions of interest are labeled in FIG. 6A. In some implementations, each target object 602 is associated with at least one RF device (not shown). In some examples, the RF device may be a type of device that can be detected from a distance, such as an RFID tag that is associated with a unique address, which would enable a monitoring system or device (e.g., RF reader) to identify the RFID tag and thus the associated target object. Other types of RF devices that may be possible to use in this scenario include an NFC chip.

In practice, warehouse objects (e.g., boxes) are typically organized and stored in some structured way, by type, size, weight, geographic destination, etc. For example, numerous boxes may be organized according to weight. As illustrated in FIG. 6A, a box in a group of boxes 620 may have a lighter weight (e.g., within a certain range or under a certain threshold) and may be placed on the uppermost shelf. A box in a group of boxes 630 may have a weight that is greater than that of a box in the group of boxes 620 and may be placed on the middle shelf. A box in a group of boxes 640 may have a weight that is greater than that of a box in the group of boxes 630 (and 620) and may be placed on the floor or the bottom shelf. In this example, the weight is not necessarily correlated to size, so some smaller boxes (shown near the lower right corner of example image 610) may still be placed on the bottom rather than the middle or top shelf.

A conventional object detector performing object detection in the example image 610 may detect target objects 602 and produce a single region of interest 604 per box such as the bounding box in solid lines. In a tightly packed or cluttered setup (e.g., with numerous boxes adjacent to and/or stacked on top of one another), the object detector might only produce a single region of interest (e.g., bounding box 644) per aisle or shelf.

However, some embodiments of the present disclosure may consider additional contextual information, such as object information, e.g., object type. If knowledge of the type of object (e.g., weight) is available, e.g., based on the unique ID or address of the RF devices associated with (e.g., inside) the target objects 602, then this knowledge can be utilized to select only the relevant regions of interest 646 in solid lines, three of which are labeled in the example image 610′ of FIG. 6B for simplicity to indicate target objects having the highest range of weights.

Moreover, an associated RF device might be placed on a specific location of the object. In some implementations, the specific location can be associated with an identifier of the RF device. For example, a device ID of an RF device placed in one corner of a box may be different from a device ID of an RF device placed in another corner of the box, e.g., top of box vs. bottom of box. However, the exact location may not be known. For example, status information pertaining to an RF device may indicate a type of placement of “corner,” leaving open the possibility of the RF device being in one of eight corners of a box.

FIG. 6C is an example image 650 of a target object 652 of FIG. 6A having multiple possible refined regions of interest 656, 658 identified according to embodiments herein (e.g., narrowed using contextual information). An RF device (e.g., RFID tag) may be placed on one of the corners of the target object 652. The possible refined regions of interest 656, 658 may be produced as bounding boxes around the corners of the objects using the status information (e.g., the type of placement “corner”). This may reduce the search space for downstream applications or actions such as positioning, as compared to using a region of interest 654 that is less refined, especially in a tightly packed or cluttered setup. By determining refined regions of interest at a corner of the target object 652 rather than around the entire target object 652 (such as with region of interest 654), identifying the target object 652 may make distinguishing which RF device is on which target object more efficient and accurate, and thereby may make identifying the target object 652 more accurately.

In some embodiments, a likelihood or probability or confidence parameter or a similar metric may be associated with each refined region of interest 656, 658. In some implementations, such confidence parameter may be determined based on additional contextual information and/or assumptions. For example, in addition to weight, orientation information may be used to assign a higher likelihood to certain corners. If a target object is in an upright orientation (detectable using various information, e.g., a “THIS WAY UP” label or arrow), it may be indicative of the RF device being attached to one of the top corners based on standard procedure at the warehouse. In particular cases, confidence parameters can be represented on the image or stored as percentages (e.g., 25%, 0.89) or as a heatmap indicating likelihoods or probabilities. Based on the confidence parameters of each of the refined regions of interest 656, 658, a refined region of interest 658 having maximum likelihood may be determined. In some implementations, this refined region of interest 658 having maximum likelihood may be used for downstream applications or actions, such as positioning of the RF device and/or the target object 652.

In some embodiments, further contextual information may no longer be collected once the confidence parameter reaches a prescribed threshold, as a high enough confidence parameter may be deemed to be sufficient to determine a refined region of interest 658 having maximum likelihood, or the downstream application or action does not require the level of accuracy that can be obtained with further contextual information. Ceasing the collection of further contextual information can save time and power associated with making requests, receiving data, processing, etc.

### Methods

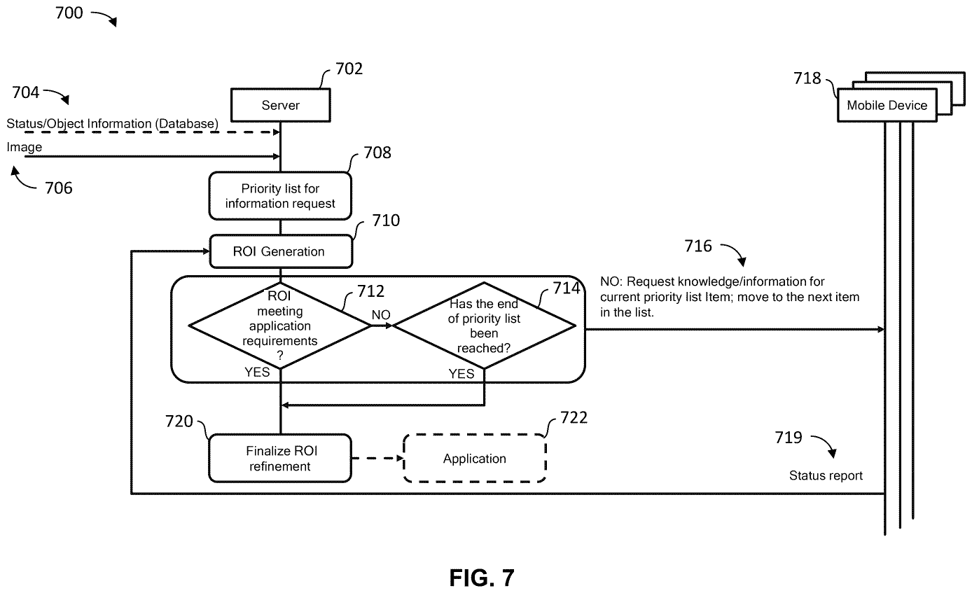

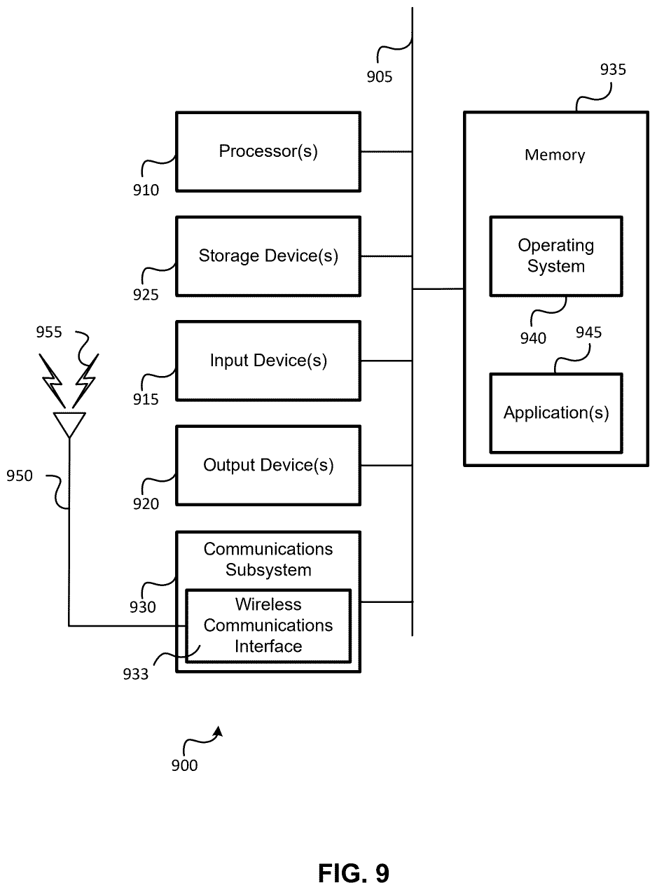

FIG. 7 is a call flow diagram 700 illustrating a process for determining a refined region of interest, according to some embodiments. Structure for performing the functionality illustrated in one or more of the operations shown in FIG. 7 may be performed by hardware and/or software components of a computer system or network apparatus, e.g., a server. Components of such computer system or network apparatus may include, for example, one or more transceivers, memory, one or more processors, and/or a computer-readable apparatus including a storage medium storing computer-readable and/or computer-executable instructions that are configured to, when executed by one or more processors, cause the one or more processors or the computerized apparatus to perform operations represented by blocks or arrows below. Example components of the computerized apparatus (e.g., server) are illustrated in FIG. 9, which are described in more detail below. It should also be noted that the operations of FIG. 7 may be performed in any suitable order, not necessarily the order depicted in FIG. 7. Further, the process shown in FIG. 7 may include additional or fewer operations than those depicted in FIG. 7 to determine the refined region of interest.

The call flow diagram 700 begins at block 702, which represents a computerized apparatus that can perform the operations described below. In some embodiments, the apparatus may be a server, such as a location server. Location server 160 and external client 180 may be examples of the apparatus. The apparatus performing one or more of the operations described below will be referred to as the server, according to some embodiments. However, the operations are not limited to performance by a server; the operations may be performed with substantially equal effectiveness by other devices. In certain embodiments, an RF device or a UE may perform at least some of the operations, provided sufficient computational resources.

In certain privacy-preserving implementations, the operations may be performed at one or more sensors (e.g., cameras or other image-capture apparatus, RF sensors), where sensor data corresponding to a scene associated with at least a portion of a target object may be captured. Raw image data and/or optical images or RF images representative of the image data may not be sent to the server, and the regions of interest may be determined and generated locally at the sensors. In such implementations, the server may send necessary information for region of interest generation and refinement to the sensors.

In some embodiments, at step 704, the server may obtain contextual information, e.g., status information and/or object information, from a database. In some cases, the information may be received from a remote storage device. In some cases, the information may be received from a local storage device (e.g., at the server). The received status information and/or the object information may include historical information obtained over a period of time and/or the most-recent information. Historical information may include, for example, a set (e.g., one or more) of previous states of the status information and/or the object information. Historical information may also include a length of the period of time over which the set of previous states were obtained or recorded. Multiple instances or records of the status or object information may indicate a change in said status over time. In an illustrative, non-limiting example, if motion information indicates that a UE is moving is in motion inconsistently but at an average of 30 miles per hour over a period of 15 minutes, with motion information obtained every minute, it may indicate that the UE is being driven or inside a vehicle. In an outdoor monitoring scenario, this historical information could indicate that the region of interest is more likely to be a vehicle or a portion of the vehicle. In another illustrative example, placement information of the target object may be different over time. For example, at a first time, the target object (or a candidate for a target object) may be placed at a first distance from another object. At a second time, the target object and the other object may be placed at a second distance (different from the first distance) apart from each other. This historical object information may include a series of distances that change once or more over time, which may be indicative of a change in location of the target object, from one shelf to another, from the user's hand to the table, etc. This historical information may assist with identifying an RF device or a target object, determining a more refined region of interest around the RF device or the target object, or even predicting where to perform a visual search to detect the RF device or the target object over time.

The database may be accessible from multiple storage devices, whether locally at the server and/or a remote database, depending on the application and configuration. That is, some pieces of contextual information may be stored and known already at the server. For example, in an industrial monitoring scenario, some of the contextual information may be stored on the server or a local database. Some of the locally stored information may include an ID of an RF device, object information (e.g., size, weight, color, type), relative placement of target objects and/or RF devices. This way, the server can retrieve the domain knowledge and information by looking up the RF device ID (e.g., in a lookup table or data structure). In some scenarios or monitoring applications, contextual information may be dynamic, changing over time (e.g., activity status). Hence, the server may communicate with a database, the RF device, or the UE to obtain it from a remote database that is acquiring contextual information over time. As will be discussed below with respect to step 716, the server may also receive additional contextual information from elsewhere, as needed.

At step 706, the server may obtain image data. In some embodiments, the image data may be received from one or more sensors or image-capturing apparatus, e.g., cameras, RF sensors, or a combination thereof. One or more images and/or RF representations or RF images may be representative of the image data. The one or more images may be of at least a target object. One or more RF devices may be associated with the target object. Examples of an RF device may include a UE, a mobile communication device, and an RFID tag. Example image 220, example image 350, example images 452a, 452b, example images 510, 520, 530, 540, example image 610, and example image 650 may be examples of an image obtained from the one or more sensors.

Not all domain knowledge and information may be necessary, particularly in public monitoring settings where user privacy considerations should be observed. In addition, if the region of interest is very small (e.g., distant targets), the additional contextual information may bring insignificant improvement. Thus, even if more contextual information may be used or obtainable, not all of it may be used when generating or receiving the refined region of interest initially at block 710. Nonetheless, the refined region of interest will be more relevant and narrowly tailored to the context, resulting in a more accurate and useful region of interest for downstream applications or actions as compared to a region of interest that does not use any contextual information (such as region of interest 316).

To the above ends, the server may use an incremental approach with respect to incorporation of the contextual information in determining a refined region of interest. The server may (1) create and maintain a contextual information priority list, and/or (2) determine whether to seek more contextual information based on reliability requirements of the downstream application or action.

In some embodiments, at block 708, the server may create, obtain, and/or maintain a priority list of the contextual information. The priority list may include a list of contextual information to be requested or obtained, arranged in order of priority. The priority assigned to the contextual information may be based on combination of criteria such as availability, quantity, or quality of the information; application or action the information will be used with; or security or user privacy considerations. In some implementations, higher-priority information may be given higher weight or higher probability when determining a refined region of interest. As an example, the refined region of interest 658 may have a higher confidence parameter based on a higher priority assigned to it, where the higher priority may be assigned based on the greater availability of information relating to the refined region of interest 658.

At block 710, the server may determine and generate, or receive (e.g., from the databased referenced with respect to step 704 or another device), a refined region of interest, according to one or more approaches and embodiments described herein. In some embodiments, generating this refined region of interest may use the status information and/or object information obtained via step 704. In some implementations, the status information and/or the object information used may be according to the priority list of block 708. For example, the top three pieces of contextual information may be used.

In some embodiments, as mentioned above, the server may determine whether to seek more contextual information depending on the current state of the region(s) of interest. The server may determine this using reliability requirements of the final application or action as a criterion by checking whether the current region(s) of interest satisfy such reliability requirements. For example, the server may determine that a downstream application or action such as positioning needs a certain level of accuracy, reliability, precision, etc. for the region of interest.

At block 712, the server may determine whether the refined region of interest meets application or action requirements. The aforementioned reliability requirements may be part of the application requirements. For example, the refined region of interest may be used for positioning of a target object (e.g., body part of a user holding a UE) as the downstream application or action. The refined region of interest may be deemed to meet application or action requirements if at least one dimension of the refined region of interest is smaller than a region of interest that would arise without refinement, or if multiple possible regions of interest having respective confidence metrics are identified (indicating refinement over a single bounding box, for instance), or if the area of bounding boxes generated are smaller than that of known ones bounding boxes (e.g., previously generated), or refined regions of interest determined multiple times do not deviate from one another (indicating precision and reliability). These are illustrative examples. Various criteria may be used to determine that the refined region of interest meets application or action requirements.

If the refined region of interest is deemed insufficient for application or action requirements (e.g., the server cannot determine an accurate (or sufficiently accurate) position of the target object), the server may further determine whether the end of the priority list has been reached, at block 714.

If not, at step 716, the server may request further knowledge or information for the current priority list item. This is part of the incremental approach mentioned above. In some cases, the request may be made to the RF device 718 (mobile communication device, UE, active RFID tag, etc.). In some cases, the request may be made to the one or more sensors to obtain contextual information from optical images (relative location, motion status, proximity status, distance, range, etc.). At step 719, the requested information may be sent to by the server.

If the end of the priority list has been reached, or if the refined region of interest meets application or action requirements, the server may proceed to finalizing refinement of the region of interest, at block 720. If further contextual information is obtained, the additional contextual information may be used to further refine the region of interest. In some cases, no further refinement may result if no further contextual information can be gathered via step 716. The finalized refined region of interest may be the same as the refined region of interest generated at block 710, or other post-processing procedures may be performed (e.g., identifying the highest maximum likelihood out of multiple possible refined regions of interest such as those shown in FIG. 6C, filtering, cropping, image segmentation). In some cases, if no refinement is possible at blocks 710 and 720 (e.g., because contextual information was not available locally, at a database, or from an RF device or UE), a “legacy” region of interest that has not experienced refinement using contextual information may be determined at block 720.

Optionally, at block 722, an application or action (also referred to herein as a downstream application or action) may be performed. The application or action may be performed with respect to a target object or an RF device, for example. Examples of downstream applications or actions that can be performed include positioning of at least a portion of the target object (e.g., portion of a user using a UE during a call, environment in which the user is using a UE using speaker mode, a box at a warehouse), generation of a visual prior (a three-dimensional representation of target object, which itself can be used for, e.g., positioning of the target object), sensor or camera calibration in which the sensor or camera uses bounding boxes or shapes around known objects (e.g., RF devices, UEs) to determine intrinsic parameters (where the better or more refined the bounding box, the better the calibration), and RF-aided object detection in which the contextual information provides accurate reference data or training data (e.g., for a machine learning model, e.g., a deep neural net model) to produce more relevant bounding boxes which can then be used for a downstream application or action mentioned above.

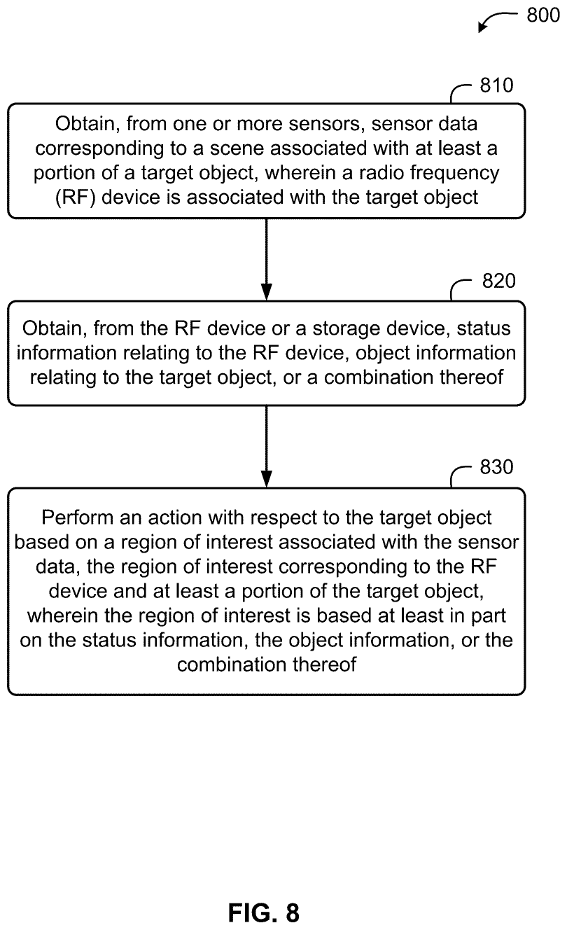

FIG. 8 is a flow diagram of a method 800 of determining a refined region of interest, according to some embodiments. Structure for performing the functionality illustrated in one or more of the blocks shown in FIG. 8 may be performed by hardware and/or software components of a computer system or a network apparatus, e.g., a server. Components of such computer system or network apparatus may include, for example, one or more transceivers, one or more processors, and/or a computer-readable apparatus including a storage medium storing computer-readable and/or computer-executable instructions that are configured to, when executed by one or more processors, cause the one or more processors or the computer system or the network apparatus to perform operations represented by blocks below. Example components of a computer system or network apparatus are illustrated in FIG. 9, which is described in more detail below. It should also be noted that the operations of FIG. 8 may be performed in any suitable order, not necessarily the order depicted in FIG. 8. Further, the process shown in FIG. 8 may include additional or fewer operations than those depicted in FIG. 8 to determine the refined region of interest.

At block 810, the method 800 may include obtaining, from one or more sensors, sensor data corresponding to a scene associated with at least a portion of a target object, wherein an RF device is associated with the target object. Sensor data may include, for example, image data from one or more cameras and/or RF sensing data from one or more RF sensors. Image data may be represented by one or more images (e.g., optical images). RF sensing data may be represented by one or more RF images or RF representations.

In some embodiments, the obtaining of the sensor data may include receiving image data associated with at least the portion of the target object from one or more cameras, RF sensing data associated with at least the portion of the target object from one or more RF sensors, or a combination thereof. The sensor data may be of a scene such as an industrial setting (e.g., warehouse), public setting, private indoor setting, etc. In some embodiments, the RF device may be a wireless or mobile communication device (e.g., UE such as a smartphone, tablet, smartwatch) or an RFID tag (active or passive), which may be attached, held by, nearby, or otherwise associated with the target object. The target object may be an inanimate object (e.g., a box), a mobile object (e.g., a car), a user, or a portion thereof (e.g., upper body of a user). In some embodiments, the RF device may include a mobile communication device or an RFID tag.

Means for performing functionality at block 810 may include a communications subsystem 930, a wireless communication interface 933, wireless antenna(s) 950, and/or other components of a server, as illustrated in FIG. 9.

At block 820, the method 800 may include obtaining, from the RF device or a storage device, status information relating to the RF device, object information relating to the target object, or a combination thereof. In some embodiments, the status information relating to the RF device may include current status information including a current state of the status information, historical status information including one or more states of the status information obtained prior to the current state, or a combination thereof; and the status information may further include one or more types of the status information, wherein the one or more types of the status information include: a communication status of the RF device, operational information of the RF device, a connectivity status of the RF device, motion information of the RF device, distance information with respect to the target object, or a combination thereof. In some embodiments, the object information relating to the target object may include current object information including a current state of the object information, historical object information including one or more states of the object information obtained prior to the current state, or a combination thereof; and the object information may further include one or more types of the object information, wherein the one or more types of the object information include: a type of the target object, a location of the target object relative to one or more other objects, a placement of the RF device relative to the target object, a type of location of the RF device relative to the target object, one or more possible placements of the RF device, or a combination thereof. These categories of status information and object information are described in more detail elsewhere herein.

In some embodiments, obtaining the status information, the object information, or the combination thereof may include: receiving at least a portion of the status information, at least a portion of the object information, or a combination thereof from the RF device; accessing at least a portion of the status information, at least a portion of the object information, or a combination thereof at the storage device; or a combination thereof.

In some embodiments, the method 800 may further include requesting, from the RF device, additional status information relating to the RF device, additional object information relating to the target object, or a combination thereof.

Means for performing functionality at block 820 may include bus 905, one or more non-transitory storage devices 925, a communications subsystem 930, a wireless communication interface 933, wireless antenna(s) 950, and/or other components of a server, as illustrated in FIG. 9.

At block 830, the method 800 may include performing an action with respect to the target object based on a region of interest associated with the sensor data, the region of interest corresponding to the RF device and at least a portion of the target object, wherein the region of interest is based at least in part on the status information, the object information, or the combination thereof. In some cases, the region of interest may be displayable and visible on a rendered image representation based on the sensor data, e.g., an optical image, RF radio image, RF representation.

In some embodiments, performing the action with respect to the target object may include positioning the target object based on the region of interest. In some embodiments, the action may include generating a visual prior (visual positioning prior), sensor or camera calibration, RF-aided object detection, providing reference data, or training a machine learning model, as discussed above with respect to block 722. In some embodiments, the action may include informing the RF device to obtain additional sensor data (e.g., image data, RF sensor data), which in some example cases may be based on boundary information (e.g., on an edge of the image data). This may be in addition to or in lieu of step 716 for the current priority list item, resulting in further incremental information, where obtaining additional image data can be used to detect, identify, or generate the target object or a refined region of interest.

In some embodiments, the region of interest may include a region associated with the at least the portion of the target object identified based on the status information relating to the RF device.

In some embodiments, the method 800 may further include determining respective likelihoods associated with a plurality of possible placements of the RF device, wherein the region of interest comprises a portion of the plurality of possible placements of the RF device determined based on the respective likelihoods. Example image 650 of FIG. 6C may be an illustrative example of the plurality of possible placements of the RF device.

In some embodiments, the method 800 may further include generating or receiving a priority list comprising a priority associated to each of the status information relating to the RF device, the object information relating to the target object, or the combination thereof, wherein the region of interest may be determined based on the priority list.

In some embodiments, the method 800 may further include requesting, from the RF device, additional status information relating to the RF device, additional object information relating to the target object, or a combination thereof.

Means for performing functionality at block 830 may include bus 905, processor(s) 910, working memory 935, one or more applications 945, and/or other components of a server, as illustrated in FIG. 9.

### Apparatus

FIG. 9 is a block diagram of an embodiment of a computer system 900, which may be used, in whole or in part, to provide the functions of one or more network components as described in the embodiments herein (e.g., location server 160 or external client 180 of FIG. 1). It should be noted that FIG. 9 is meant only to provide a generalized illustration of various components, any or all of which may be utilized as appropriate. FIG. 9, therefore, broadly illustrates how individual system elements may be implemented in a relatively separated or relatively more integrated manner. In addition, it can be noted that components illustrated by FIG. 9 can be localized to a single device and/or distributed among various networked devices, which may be disposed at different geographical locations.

The computer system 900 is shown comprising hardware elements that can be electrically coupled via a bus 905 (or may otherwise be in communication, as appropriate). The hardware elements may include processor(s) 910, which may comprise without limitation one or more general-purpose processors, one or more special-purpose processors (such as digital signal processing chips, graphics acceleration processors, and/or the like), and/or other processing structure, which can be configured to perform one or more of the methods described herein. The computer system 900 also may comprise one or more input devices 915, which may comprise without limitation a mouse, a keyboard, a camera, a microphone, and/or the like; and one or more output devices 920, which may comprise without limitation a display device, a printer, and/or the like.

The computer system 900 may further include (and/or be in communication with) one or more non-transitory storage devices 925, which can comprise, without limitation, local and/or network accessible storage, and/or may comprise, without limitation, a disk drive, a drive array, an optical storage device, a solid-state storage device, such as a RAM and/or ROM, which can be programmable, flash-updateable, and/or the like. Such storage devices may be configured to implement any appropriate data stores, including without limitation, various file systems, database structures, and/or the like. Such data stores may include database(s) and/or other data structures used store and administer messages and/or other information to be sent to one or more devices via hubs, as described herein.

The computer system 900 may also include a communications subsystem 930, which may comprise wireless communication technologies managed and controlled by a wireless communication interface 933, as well as wired technologies (such as Ethernet, coaxial communications, universal serial bus (USB), and the like). The wireless communication interface 933 may comprise one or more wireless transceivers that may send and receive wireless signals 955 (e.g., signals according to 5G NR or LTE) via wireless antenna(s) 950. Thus the communications subsystem 930 may comprise a modem, a network card (wireless or wired), an infrared communication device, a wireless communication device, and/or a chipset, and/or the like, which may enable the computer system 900 to communicate on any or all of the communication networks described herein to any device on the respective network, including a User Equipment (UE), base stations and/or other TRPs, and/or any other electronic devices described herein. Hence, the communications subsystem 930 may be used to receive and send data as described in the embodiments herein.

In many embodiments, the computer system 900 will further comprise a working memory 935, which may comprise a RAM or ROM device, as described above. Software elements, shown as being located within the working memory 935, may comprise an operating system 940, device drivers, executable libraries, and/or other code, such as one or more applications 945, which may comprise computer programs provided by various embodiments, and/or may be designed to implement methods, and/or configure systems, provided by other embodiments, as described herein. Merely by way of example, one or more procedures described with respect to the method(s) discussed above might be implemented as code and/or instructions executable by a computer (and/or a processor within a computer); in an aspect, then, such code and/or instructions can be used to configure and/or adapt a general purpose computer (or other device) to perform one or more operations in accordance with the described methods.

A set of these instructions and/or code might be stored on a non-transitory computer-readable storage medium, such as the storage device(s) 925 described above. In some cases, the storage medium might be incorporated within a computer system, such as computer system 900. In other embodiments, the storage medium might be separate from a computer system (e.g., a removable medium, such as an optical disc), and/or provided in an installation package, such that the storage medium can be used to program, configure, and/or adapt a general purpose computer with the instructions/code stored thereon. These instructions might take the form of executable code, which is executable by the computer system 900 and/or might take the form of source and/or installable code, which, upon compilation and/or installation on the computer system 900 (e.g., using any of a variety of generally available compilers, installation programs, compression/decompression utilities, etc.), then takes the form of executable code.

It will be apparent to those skilled in the art that substantial variations may be made in accordance with specific requirements. For example, customized hardware might also be used and/or particular elements might be implemented in hardware, software (including portable software, such as applets, etc.), or both. Further, connection to other computing devices such as network input/output devices may be employed.

With reference to the appended figures, components that can include memory can include non-transitory machine-readable media. The term “machine-readable medium” and “computer-readable medium” as used herein, refer to any storage medium that participates in providing data that causes a machine to operate in a specific fashion. In embodiments provided hereinabove, various machine-readable media might be involved in providing instructions/code to processors and/or other device(s) for execution. Additionally or alternatively, the machine-readable media might be used to store and/or carry such instructions/code. In many implementations, a computer-readable medium is a physical and/or tangible storage medium. Such a medium may take many forms, including but not limited to, non-volatile media and volatile media. Common forms of computer-readable media include, for example, magnetic and/or optical media, any other physical medium with patterns of holes, a RAM, a programmable ROM (PROM), erasable PROM (EPROM), a FLASH-EPROM, any other memory chip or cartridge, or any other medium from which a computer can read instructions and/or code.

The methods, systems, and devices discussed herein are examples. Various embodiments may omit, substitute, or add various procedures or components as appropriate. For instance, features described with respect to certain embodiments may be combined in various other embodiments. Different aspects and elements of the embodiments may be combined in a similar manner. The various components of the figures provided herein can be embodied in hardware and/or software. Also, technology evolves and, thus many of the elements are examples that do not limit the scope of the disclosure to those specific examples.

It has proven convenient at times, principally for reasons of common usage, to refer to such signals as bits, information, values, elements, symbols, characters, variables, terms, numbers, numerals, or the like. It should be understood, however, that all of these or similar terms are to be associated with appropriate physical quantities and are merely convenient labels. Unless specifically stated otherwise, as is apparent from the discussion above, it is appreciated that throughout this Specification discussion utilizing terms such as “processing,” “computing,” “calculating,” “determining,” “ascertaining,” “identifying,” “associating,” “measuring,” “performing,” or the like refer to actions or processes of a specific apparatus, such as a special purpose computer or a similar special purpose electronic computing device. In the context of this Specification, therefore, a special purpose computer or a similar special purpose electronic computing device is capable of manipulating or transforming signals, typically represented as physical electronic, electrical, or magnetic quantities within memories, registers, or other information storage devices, transmission devices, or display devices of the special purpose computer or similar special purpose electronic computing device.

Terms, “and” and “or” as used herein, may include a variety of meanings that also is expected to depend, at least in part, upon the context in which such terms are used. Typically, “or” if used to associate a list, such as A, B, or C, is intended to mean A, B, and C, here used in the inclusive sense, as well as A, B, or C, here used in the exclusive sense. In addition, the term “one or more” as used herein may be used to describe any feature, structure, or characteristic in the singular or may be used to describe some combination of features, structures, or characteristics. However, it should be noted that this is merely an illustrative example and claimed subject matter is not limited to this example. Furthermore, the term “at least one of” if used to associate a list, such as A, B, or C, can be interpreted to mean any combination of A, B, and/or C, such as A, AB, AA, AAB, AABBCCC, etc.

Having described several embodiments, various modifications, alternative constructions, and equivalents may be used without departing from the scope of the disclosure. For example, the above elements may merely be a component of a larger system, wherein other rules may take precedence over or otherwise modify the application of the various embodiments. Also, a number of steps may be undertaken before, during, or after the above elements are considered. Accordingly, the above description does not limit the scope of the disclosure.

In view of this description embodiments may include different combinations of features. Implementation examples are described in the following numbered clauses:

Clause 1. A method of determining a refined region of interest associated with a radio frequency (RF) device, the method comprising: obtaining, from one or more sensors, sensor data corresponding to a scene associated with at least a portion of a target object, wherein the RF device is associated with the target object; obtaining, from the RF device or a storage device, status information relating to the RF device, object information relating to the target object, or a combination thereof; and performing an action with respect to the target object based on a region of interest associated with the sensor data, the region of interest corresponding to the RF device and at least a portion of the target object, wherein the region of interest is based at least in part on the status information, the object information, or the combination thereof.

Clause 2. The method of clause 1, wherein performing the action with respect to the target object comprises positioning the target object based on the region of interest.

Clause 3. The method of any one of clauses 1-2 wherein the one or more sensors comprise one or more cameras, one or more radio frequency (RF) sensors, or a combination thereof; and obtaining the sensor data comprises receiving image data associated with at least the portion of the target object from the one or more cameras, RF sensing data associated with at least the portion of the target object from the one or more RF sensors, or a combination thereof.

Clause 4. The method of any one of clauses 1-3 wherein the status information relating to the RF device comprises current status information comprising a current state of the status information, historical status information comprising one or more states of the status information obtained prior to the current state, or a combination thereof; and the status information further comprises one or more types of the status information, wherein the one or more types of the status information comprise: a communication status of the RF device, operational information of the RF device, a connectivity status of the RF device, motion information of the RF device, distance information with respect to the target object, or a combination thereof.

Clause 5. The method of any one of clauses 1-4 wherein the region of interest comprises a region associated with the at least the portion of the target object identified based on the status information relating to the RF device.

Clause 6. The method of any one of clauses 1-5 wherein the object information relating to the target object comprises current object information comprising a current state of the object information, historical object information comprising one or more states of the object information obtained prior to the current state, or a combination thereof; and the object information further comprises one or more types of the object information, wherein the one or more types of the object information comprise: a type of the target object, a location of the target object relative to one or more other objects, a placement of the RF device relative to the target object, a type of location of the RF device relative to the target object, one or more possible placements of the RF device, or a combination thereof.

Clause 7. The method of any one of clauses 1-6 further comprising determining respective likelihoods associated with a plurality of possible placements of the RF device; wherein the region of interest comprises a portion of the plurality of possible placements of the RF device determined based on the respective likelihoods.

Clause 8. The method of any one of clauses 1-7 wherein obtaining the status information, the object information, or the combination thereof comprises: receiving at least a portion of the status information, at least a portion of the object information, or a combination thereof from the RF device; accessing at least a portion of the status information, at least a portion of the object information, or a combination thereof at the storage device; or a combination thereof.

Clause 9. The method of any one of clauses 1-8 further comprising generating or receiving a priority list comprising a priority associated to each of the status information relating to the RF device, the object information relating to the target object, or the combination thereof; wherein the region of interest is determined based on the priority list.

Clause 10. The method of any one of clauses 1-9 further comprising requesting, from the RF device, additional status information relating to the RF device, additional object information relating to the target object, or a combination thereof.

Clause 11. A network apparatus comprising: one or more communication interfaces configured for data communication with one or more sensors and a storage device; one or more memory; and one or more processors communicatively coupled to the one or more communication interfaces and the one or more memory, and configured to: obtain, from the one or more sensors, sensor data corresponding to a scene associated with at least a portion of a target object, wherein the RF device is associated with the target object; obtain, from the RF device or the storage device, status information relating to the RF device, object information relating to the target object, or a combination thereof; and perform an action with respect to the target object based on a region of interest associated with the sensor data, the region of interest corresponding to the RF device and at least a portion of the target object, wherein the region of interest is based at least in part on the status information, the object information, or the combination thereof.

Clause 12. The network apparatus of clause 11, wherein performing the action with respect to the target object comprises positioning the target object based on the region of interest.

Clause 13. The network apparatus of any one of clauses 11-12 wherein the one or more sensors comprise one or more cameras, one or more radio frequency (RF) sensors, or a combination thereof; and obtaining the sensor data comprises receiving image data associated with at least the portion of the target object from the one or more cameras, RF sensing data associated with at least the portion of the target object from the one or more RF sensors, or a combination thereof.

Clause 14. The network apparatus of any one of clauses 11-13 wherein the status information relating to the RF device comprises current status information comprising a current state of the status information, historical status information comprising one or more states of the status information obtained prior to the current state, or a combination thereof; and the status information further comprises one or more types of the status information, wherein the one or more types of the status information comprise: a communication status of the RF device, operational information of the RF device, a connectivity status of the RF device, motion information of the RF device, distance information with respect to the target object, or a combination thereof.

Clause 15. The network apparatus of any one of clauses 11-14 wherein the region of interest comprises a region associated with the at least the portion of the target object identified based on the status information relating to the RF device.

Clause 16. The network apparatus of any one of clauses 11-15 wherein the object information relating to the target object comprises current object information comprising a current state of the object information, historical object information comprising one or more states of the object information obtained prior to the current state, or a combination thereof; and the object information further comprises one or more types of the object information, wherein the one or more types of the object information comprise: a type of the target object, a location of the target object relative to one or more other objects, a placement of the RF device relative to the target object, a type of location of the RF device relative to the target object, one or more possible placements of the RF device, or a combination thereof.

Clause 17. The network apparatus of any one of clauses 11-16 wherein the one or more processors are further configured to determine respective likelihoods associated with a plurality of possible placements of the RF device; wherein the region of interest comprises a portion of the plurality of possible placements of the RF device determined based on the respective likelihoods.

Clause 18. The network apparatus of any one of clauses 11-17 wherein obtaining the status information, the object information, or the combination thereof comprises: receiving at least a portion of the status information, at least a portion of the object information, or a combination thereof from the RF device; accessing at least a portion of the status information, at least a portion of the object information, or a combination thereof at the storage device; or a combination thereof.

Clause 19. The network apparatus of any one of clauses 11-18 wherein the one or more processors are further configured to generate or receive a priority list comprising a priority associated to each of the status information relating to the RF device, the object information relating to the target object, or the combination thereof; wherein the region of interest is determined based on the priority list.

Clause 20. The network apparatus of any one of clauses 11-19 wherein the one or more processors are further configured to request, from the RF device, additional status information relating to the RF device, additional object information relating to the target object, or a combination thereof.

Clause 21. A non-transitory computer-readable apparatus comprising a storage medium, the storage medium comprising a plurality of instructions configured to, when executed by one or more processors, cause a computerized apparatus to: obtain, from one or more sensors, sensor data corresponding to a scene associated with at least a portion of a target object, wherein the RF device is associated with the target object; obtain, from the RF device or a storage device, status information relating to the RF device, object information relating to the target object, or a combination thereof; and perform an action with respect to the target object based on a region of interest associated with the sensor data, the region of interest corresponding to the RF device and at least a portion of the target object, wherein the region of interest is based at least in part on the status information, the object information, or the combination thereof.

Clause 22. £ The non-transitory computer-readable apparatus of clause 21, wherein performing the action with respect to the target object comprises positioning the target object based on the region of interest.

Clause 23. The non-transitory computer-readable apparatus of any one of clauses 21-22 wherein the one or more sensors comprise one or more cameras, one or more radio frequency (RF) sensors, or a combination thereof; obtaining the sensor data comprises receiving image data associated with at least the portion of the target object from the one or more cameras, RF sensing data associated with at least the portion of the target object from the one or more RF sensors, or a combination thereof.

Clause 24. The non-transitory computer-readable apparatus of any one of clauses 21-23 wherein the status information relating to the RF device comprises current status information comprising a current state of the status information, historical status information comprising one or more states of the status information obtained prior to the current state, or a combination thereof; and the status information further comprises one or more types of the status information, wherein the one or more types of the status information comprise: a communication status of the RF device, operational information of the RF device, a connectivity status of the RF device, motion information of the RF device, distance information with respect to the target object, or a combination thereof.

Clause 25. The non-transitory computer-readable apparatus of any one of clauses 21-24 wherein the object information relating to the target object comprises current object information comprising a current state of the object information, historical object information comprising one or more states of the object information obtained prior to the current state, or a combination thereof; and the object information further comprises one or more types of the object information, wherein the one or more types of the object information comprise: a type of the target object, a location of the target object relative to one or more other objects, a placement of the RF device relative to the target object, a type of location of the RF device relative to the target object, one or more possible placements of the RF device, or a combination thereof.

Clause 26. The non-transitory computer-readable apparatus of any one of clauses 21-25 wherein obtaining the status information, the object information, or the combination thereof comprises: receiving at least a portion of the status information, at least a portion of the object information, or a combination thereof from the RF device; accessing at least a portion of the status information, at least a portion of the object information, or a combination thereof at the storage device; or a combination thereof.

Clause 27. An apparatus comprising: means for obtaining, from one or more sensors, sensor data corresponding to a scene associated with at least a portion of a target object, wherein the RF device is associated with the target object; means for obtaining, from the RF device or a storage device, status information relating to the RF device, object information relating to the target object, or a combination thereof; and means for performing an action with respect to the target object based on a region of interest associated with the sensor data, the region of interest corresponding to the RF device and at least a portion of the target object, wherein the region of interest is based at least in part on the status information, the object information, or the combination thereof.

Clause 28. The apparatus of clause 27, wherein the means for performing the action with respect to the target object comprises means for positioning the target object based on the region of interest.

Clause 29. The apparatus of any one of clauses 27-28 wherein the one or more sensors comprise one or more cameras, one or more radio frequency (RF) sensors, or a combination thereof; and the means for obtaining the sensor data comprises receiving image data associated with at least the portion of the target object from the one or more cameras, RF sensing data associated with at least the portion of the target object from the one or more RF sensors, or a combination thereof.

Clause 30. The apparatus of any one of clauses 27-29 wherein the status information relating to the RF device comprises: a communication status of the RF device, operational information of the RF device, a connectivity status of the RF device, motion information of the RF device, distance information with respect to the target object, or a combination thereof, and the object information relating to the target object comprises: a type of the target object, a location of the target object relative to one or more other objects, a placement of the RF device relative to the target object, a type of location of the RF device relative to the target object, one or more possible placements of the RF device, or a combination thereof.

1. A method of determining a refined region of interest associated with a radio frequency (RF) device, the method comprising:
obtaining, from one or more sensors, sensor data corresponding to a scene associated with at least a portion of a target object, wherein the RF device is associated with the target object;
obtaining, from the RF device or a storage device, status information relating to the RF device, object information relating to the target object, or a combination thereof; and
performing an action with respect to the target object based on a region of interest associated with the sensor data, the region of interest corresponding to the RF device and at least a portion of the target object, wherein the region of interest is based at least in part on the status information, the object information, or the combination thereof.

2. The method of claim 1, wherein performing the action with respect to the target object comprises positioning the target object based on the region of interest.

3. The method of claim 1, wherein:
the one or more sensors comprise one or more cameras, one or more radio frequency (RF) sensors, or a combination thereof; and
obtaining the sensor data comprises receiving image data associated with at least the portion of the target object from the one or more cameras, RF sensing data associated with at least the portion of the target object from the one or more RF sensors, or a combination thereof.

4. The method of claim 1, wherein:
the status information relating to the RF device comprises current status information comprising a current state of the status information, historical status information comprising one or more states of the status information obtained prior to the current state, or a combination thereof; and
the status information further comprises one or more types of the status information, wherein the one or more types of the status information comprise: a communication status of the RF device, operational information of the RF device, a connectivity status of the RF device, motion information of the RF device, distance information with respect to the target object, or a combination thereof.

5. The method of claim 4, wherein the region of interest comprises a region associated with the at least the portion of the target object identified based on the status information relating to the RF device.

6. The method of claim 1, wherein:
the object information relating to the target object comprises current object information comprising a current state of the object information, historical object information comprising one or more states of the object information obtained prior to the current state, or a combination thereof; and
the object information further comprises one or more types of the object information, wherein the one or more types of the object information comprise: a type of the target object, a location of the target object relative to one or more other objects, a placement of the RF device relative to the target object, a type of location of the RF device relative to the target object, one or more possible placements of the RF device, or a combination thereof.

7. The method of claim 6, further comprising determining respective likelihoods associated with a plurality of possible placements of the RF device;
wherein the region of interest comprises a portion of the plurality of possible placements of the RF device determined based on the respective likelihoods.

8. The method of claim 1, wherein obtaining the status information, the object information, or the combination thereof comprises:
receiving at least a portion of the status information, at least a portion of the object information, or a combination thereof from the RF device;
accessing at least a portion of the status information, at least a portion of the object information, or a combination thereof at the storage device; or
a combination thereof.

9. The method of claim 1, further comprising generating or receiving a priority list comprising a priority associated to each of the status information relating to the RF device, the object information relating to the target object, or the combination thereof;
wherein the region of interest is determined based on the priority list.

10. (canceled)

11. A network apparatus comprising:
one or more communication interfaces configured for data communication with one or more sensors and a storage device;
one or more memory; and
one or more processors communicatively coupled to the one or more communication interfaces and the one or more memory, and configured to:
obtain, from the one or more sensors, sensor data corresponding to a scene associated with at least a portion of a target object, wherein the RF device is associated with the target object;
obtain, from the RF device or the storage device, status information relating to the RF device, object information relating to the target object, or a combination thereof; and
perform an action with respect to the target object based on a region of interest associated with the sensor data, the region of interest corresponding to the RF device and at least a portion of the target object, wherein the region of interest is based at least in part on the status information, the object information, or the combination thereof.

12. The network apparatus of claim 11, wherein performing the action with respect to the target object comprises positioning the target object based on the region of interest.

13. The network apparatus of claim 11, wherein:
the one or more sensors comprise one or more cameras, one or more radio frequency (RF) sensors, or a combination thereof; and
obtaining the sensor data comprises receiving image data associated with at least the portion of the target object from the one or more cameras, RF sensing data associated with at least the portion of the target object from the one or more RF sensors, or a combination thereof.

14. The network apparatus of claim 11, wherein the status information relating to the RF device comprises current status information comprising a current state of the status information, historical status information comprising one or more states of the status information obtained prior to the current state, or a combination thereof; and
the status information further comprises one or more types of the status information, wherein the one or more types of the status information comprise: a communication status of the RF device, operational information of the RF device, a connectivity status of the RF device, motion information of the RF device, distance information with respect to the target object, or a combination thereof.

15. The network apparatus of claim 14, wherein the region of interest comprises a region associated with the at least the portion of the target object identified based on the status information relating to the RF device.

16. The network apparatus of claim 11, wherein:
the object information relating to the target object comprises current object information comprising a current state of the object information, historical object information comprising one or more states of the object information obtained prior to the current state, or a combination thereof; and
the object information further comprises one or more types of the object information, wherein the one or more types of the object information comprise: a type of the target object, a location of the target object relative to one or more other objects, a placement of the RF device relative to the target object, a type of location of the RF device relative to the target object, one or more possible placements of the RF device, or a combination thereof.

17. The network apparatus of claim 16, wherein the one or more processors are further configured to determine respective likelihoods associated with a plurality of possible placements of the RF device;
wherein the region of interest comprises a portion of the plurality of possible placements of the RF device determined based on the respective likelihoods.

18. The network apparatus of claim 11, wherein obtaining the status information, the object information, or the combination thereof comprises:
receiving at least a portion of the status information, at least a portion of the object information, or a combination thereof from the RF device;
accessing at least a portion of the status information, at least a portion of the object information, or a combination thereof at the storage device; or
a combination thereof.

19. The network apparatus of claim 11, wherein the one or more processors are further configured to generate or receive a priority list comprising a priority associated to each of the status information relating to the RF device, the object information relating to the target object, or the combination thereof;
wherein the region of interest is determined based on the priority list.

20. (canceled)

21. (canceled)

22. (canceled)

23. (canceled)

24. (canceled)

25. (canceled)

26. (canceled)

27. An apparatus comprising:
means for obtaining, from one or more sensors, sensor data corresponding to a scene associated with at least a portion of a target object, wherein the RF device is associated with the target object;
means for obtaining, from the RF device or a storage device, status information relating to the RF device, object information relating to the target object, or a combination thereof; and
means for performing an action with respect to the target object based on a region of interest associated with the sensor data, the region of interest corresponding to the RF device and at least a portion of the target object, wherein the region of interest is based at least in part on the status information, the object information, or the combination thereof.

28. The apparatus of claim 27, wherein the means for performing the action with respect to the target object comprises means for positioning the target object based on the region of interest.

29. (canceled)

30. (canceled)
